(19) United States
(12) Patent Application Publication
(10) Pub. No.: US 2026/0023470 A1
(43) Pub. Date: Jan. 22, 2026

(54) Systems and methods for generating a design

(71) Applicant: Canva Pty Ltd, Surry Hills (AU)

(72) Inventor: Kerry Jayne HALUPKA, Melbourne (AU)

(73) Assignee: Canva Pty Ltd, Surry Hills (AU)

(21) Appl. No.: 19/270,395

(22) Filed: Jul. 15, 2025

(30) Foreign Application Priority Data
Jul. 22, 2024 (AU) 2024205023

(51) Int. Cl. G06F 3/04845; G06F 3/0482

(52) U.S. Cl. CPC G06F 3/04845; G06F 3/0482

(57) ABSTRACT

Described herein is a computer implemented method for generating a final design based on a source design. The method includes: processing the source design using one or more processing units to identify a set of source elements and generating source element data that includes a first source element representation that is a representation of the semantic content of a first source element; and accessing candidate element data that includes candidate element representation in respect of a set of candidate elements, each candidate element representation being a representation of the semantic content of the corresponding candidate element. The method further includes identifying a set of replacement elements for the set of source elements based on the source element data and candidate element data and generating a final design based on the source design and the set of replacement elements.

### CROSS REFERENCE TO RELATED APPLICATION

This application is a U.S. Non-Provisional Application that claims priority to Australian Patent Application No. 2024205023, filed Jul. 22, 2024, which is hereby incorporated by reference in its entirety.

### FIELD

Embodiments of the present disclosure are directed to systems and methods for generating a design.

### BACKGROUND

Various computer applications for creating and publishing graphic designs exist. Generally speaking, such applications allow users to create a design by, for example, creating a page and adding design elements to that page.

Once a design element has been added to a page, applications typically provide mechanisms by which a user can modify the element—for example by replacing the element with another element.

Background information described in this specification is background information known to the inventors. Reference to this information as background information is not an acknowledgment or suggestion that this background information is prior art or is common general knowledge to a person of ordinary skill in the art.

### SUMMARY

Described herein is a computer implemented method for generating a final design based on a source design, the method including: processing the source design using one or more processing units to identify a set of source elements, wherein the set of source elements includes one or more elements of the source design and includes a first source element; processing the set of source elements to generate source element data, wherein generating the source element data includes generating first source element data in respect of the first source element, and wherein the first source element data includes a first source element representation that is a representation of the semantic content of the first source element; accessing candidate element data in respect of a set of candidate elements, wherein the set of candidate elements includes a plurality of candidate elements and the candidate element data includes a candidate element representation for each candidate element in the set of candidate elements, and wherein each candidate element representation is a representation of the semantic content of the corresponding candidate element; identifying a set of replacement elements for the set of source elements, wherein the set of replacement elements is identified based on the source element data and the candidate element data and wherein identifying the set of replacement elements includes identifying a first candidate element from the set of candidate elements as a replacement for the first source element based on the first source element representation and a first candidate element representation in respect of the first candidate element; and generating a final design based on the source design and the set of replacement elements, wherein in the final design the first candidate element is used in place of the first source element.

### BRIEF DESCRIPTION OF THE DRAWINGS

Preferred embodiments of the present disclosure will be described, by way of example only, with reference to the accompanying representations, wherein:

FIG. 1 is a diagram depicting a networked environment in which various features of the present disclosure may be implemented.

FIG. 2 is a block diagram of a computer processing system configurable to perform various features of the present disclosure.

FIG. 3 is a block diagram depicting a simplified and partial example of a design editor user interface.

FIG. 4 is a flowchart depicting operations performed in a method for generating a design based on a source design.

FIG. 5 is a flowchart depicting operations performed in a method for determining a set of replacement elements for a set of source elements.

FIG. 6 is a flowchart depicting operations performed in an alternative method for determining a set of replacement elements for a set of source elements.

FIG. 7 is a flowchart depicting operations performed in another alternative method for determining a set of replacement elements for a set of source elements.

FIG. 8 is a flowchart depicting operations performed in another method for generating a design based on a source design.

FIG. 9 is a flowchart depicting operations performed in a method for calculating a score that can be used to determine whether a particular candidate element should be selected as a replacement for a particular source element.

FIG. 10 is a flowchart depicting operations performed in a method for processing a set of elements to identify collections therein.

FIG. 11 is a flowchart depicting example operations performed in a method for customising a design.

FIG. 12 is a flowchart depicting example operations performed in a method for replacing an asset in one or more designs.

FIG. 13 is a flowchart depicting example operations performed in a method for determining element collections within a set of element collections.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the present invention. It will be apparent, however, that the present invention may be practiced without these specific details. In some instances, well-known structures and devices are shown in block-diagram form in order to avoid unnecessary obscuring.

As discussed above, computer applications for use in creating graphic designs are known. Such applications will typically provide mechanisms for a user to create a design and modify elements of a design. In such applications, one way in which new (or amended) designs can be created is to replace one or more elements of an existing design, hereinafter referred to as a source design. For example, a user may manually select a replacement element for each source design element that is to be replaced and then create a new (or updated) design based on the existing design and the replacement elements.

In such a process, manually selecting replacement elements can be time consuming for a user. Manually selecting replacement elements can also consume computational and/or communications (e.g. network) resources. For example, to allow a user to select replacement elements a large numbers of candidate elements may need to be retrieved (potentially from a networked location) and displayed so a user can view the available elements and select replacements therefrom.

Furthermore, when generating a new design based on a source design it is typically desirable that a final design stays or becomes aesthetically pleasing. The overall appearance of a final design can be compromised if individual replacement elements are poorly chosen or if a set of replacement elements that has been selected for a design do not work together as a whole. For certain users (e.g. those with limited design experience) this can make identifying appropriate replacement elements very difficult. Even for experienced users, this can make identifying appropriate replacement elements very time consuming and (again) require the user to retrieve and view large numbers of potential elements before being able to select replacement elements that are appropriate individually and as a set.

Certain embodiments described herein are directed to systems and methods for processing a source design to automatically identify replacement elements for one or more of the source design's original elements (referred to as source elements). A final design is then generated based on the source design and the replacement elements. Such systems and methods may be used in various scenarios.

One example scenario is to process a source design to generate a customised version of that design by replacing all or a subset of the source design's elements. This process may be generally referred to as design customisation. As one example of design customisation, a user may wish to generate a single new design by customising a single existing design (e.g. a template design that is provided by the design application or an alternative existing design) by replacing certain elements of the existing design with new elements (for example elements that are chosen from the user's own photo library or the like). As another example of design customisation, a user may wish to generate multiple new designs based on multiple existing designs. For example, a design application may provide a set of template designs that have been generated for a particular geographic location and which include elements (e.g. images) from (or relevant to) that particular location. In order to generate a set of templates that are relevant to a different location, it may be desirable to automatically generate a new set of templates that are based on the existing templates but that include elements (e.g. images) that are taken from (or relevant to) that different location.

An alternative scenario may arise if a user wishes to update a (or typically multiple) designs to replace a particular asset that is used in that/those design(s)—e.g. a particular image or other type of element. This may be referred to as an asset replacement process. For example, a user may want to replace a logo/brand image that has been used across multiple designs by finding each instance of the logo and replacing it with an alternative element.

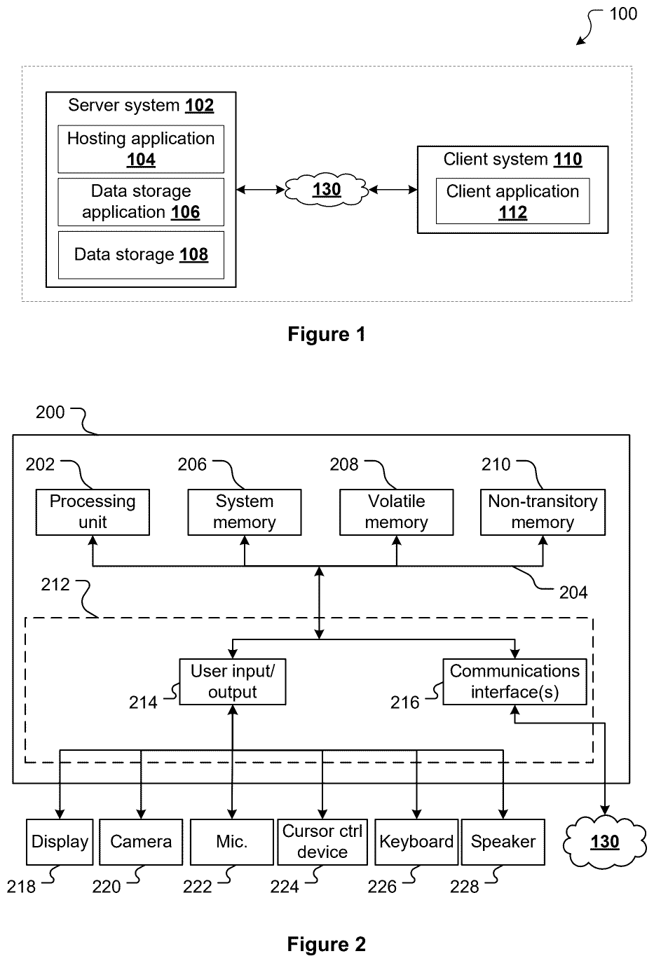

FIG. 1 is a diagram depicting a networked environment 100 in which various features of the present disclosure may be implemented.

The networked environment 100 includes a server system 102 and a client system 110 which communicate via one or more communication networks 130 (e.g., the Internet).

Generally speaking, the server system 102 includes computer processing hardware (e.g., one or more computer processing systems such as system 200 described below) on which applications that provide server-side functionality to client applications such as client application 112 (described below) execute. In the present example, the server system 102 includes what will be referred to as a hosting application 104, a data storage application 106, and a data storage 108.

In the present embodiment, the hosting application 104 executes to provide client application endpoints accessible over the communication network 130. In the present example, the hosting application 104 serves web browser client applications and, accordingly, is a web server application which receives and responds (for example) to HTTP requests. In alternative embodiments, the hosting application 104 may serve a native client application (e.g., the client application 112), in which case it will be an application server configured to receive, process, and respond to specifically defined API calls received from such a client application.

In the present example, the hosting application 104 (and/or other applications of the server system 102) facilitates various functions related to replacing elements of a design according to the embodiments of the present disclosure. These may include, for example, design creation, modification, storage, organisation, searching, retrieval, viewing, publishing, asset searching across several designs, and/or other functions related to replacing elements of designs.

The hosting application 104 (and/or other applications) may also facilitate additional, related functions such as user account creation and management, user group creation and management, user and user group permission management, user authentication, and/or other server-side functions.

In the present example, the data storage application 106 executes to receive and process requests to persistently store and retrieve data relevant to the operations performed/services provided by the server system 102. Such requests may be received from the client application 112, the hosting application 104, and/or other server system applications. Data relevant to the operations performed/services provided by the server system 102 may include, for example, user account data, design data (i.e. data describing designs that have been created by users and/or template designs available to users), asset data (e.g., data in respect of stock elements (such as images or other types of media) that are available for use by users), asset usage data (as described below), and/or other data relevant to the operation of the server system 102. Such data may be stored on/retrieved from the data storage 108.

The data storage 108 may, for example, be a relational database management application or an alternative application for storing and retrieving data from one or more data storage devices (e.g., one or more non-transitory computer readable storage devices such as hard disks, solid state drives, tape drives, or alternative computer readable storage devices, not shown).

The client application 112 is executed by its respective system 110 to configure that system to provide client-side functionality to applications of the server system 102 (e.g., hosting application 104). Via the client application 112, and as discussed in detail below, users can access the various techniques described herein.

The client application 112 may, for example, be a general web browser application which accesses the relevant server application (e.g., the hosting application 104) via an appropriate uniform resource locator (URL) and communicates with the server application 104 via general world-wide-web protocols (e.g., http, https, ftp).

In the example methods described below various operations are described as being performed by either the client application 112 or the hosting application 104. In many instances, however, operations described as being performed by a particular application (e.g., the client application 112 or the hosting application 104) could be performed by (or in conjunction with) one or more alternative applications. Furthermore, in many instances operations described as being performed by multiple separate applications could be performed by a single application. For example, in certain cases processing that is described below as being performed by the hosting application 104 could alternatively be performed by the client application 112 (or by an alternative server-or client-side application). As another example, the methods described below could be performed (or be adapted to be performed by) a single system (e.g. a user's computer system) with all operations performed by one or more applications running on that system.

The techniques and operations described herein are performed by one or more computer processing systems.

By way of example, the client system 110 may be any computer processing system which is configured (or configurable) by hardware and/or software (e.g., the client application 112) to offer client-side functionality. Such a system may be a desktop computer, laptop computer, tablet computing device, mobile/smart phone, or other appropriate computer processing system.

Similarly, the applications of the server system 102 are also executed by one or more computer processing systems. Server environment computer processing systems will typically be server systems, though again may be any appropriate computer processing systems.

FIG. 2 provides a block diagram of a computer processing system 200 configurable to implement embodiments and/or features described herein. The system 200 is a general-purpose computer processing system. It will be appreciated that FIG. 2 does not illustrate all functional or physical components of a computer processing system. For example, no power supply or power supply interface has been depicted, however, system 200 will either carry a power supply or be configured for connection to a power supply (or both). It will also be appreciated that different types of computer processing systems may have different hardware and architectures than the hardware and architecture that is depicted and described in the present example.

The computer processing system 200 includes at least one processing unit 202. The processing unit 202 may be a single computer processing device (e.g., a central processing unit, graphics processing unit, or other computational device), or may include a plurality of computer processing devices. In some instances, where a computer processing system 200 is described as performing an operation or function, all processing required to perform that operation or function will be performed by the processing unit 202. In other instances, processing required to perform that operation or function may also be performed by remote processing devices accessible to and useable by the system 200.

Through a communications bus 204 the processing unit 202 is in data communication with a one or more machine readable storage (memory) devices which store computer readable instructions and/or data which are executed by the processing unit 202 to control operation of the processing system 200. In this example, the system 200 includes a system memory 206 (e.g., a BIOS), volatile memory 208 (e.g., random-access memory such as one or more DRAM modules), and non-transitory memory 210 (e.g., one or more hard disk or solid-state drives).

The system 200 also includes one or more interfaces, indicated generally by 212, via which the system 200 interfaces with various devices and/or networks. Generally speaking, other devices may be integral with the system 200, or may be separate. Where a device is separate from the system 200, the connection between the device and the system 200 may be via wired or wireless hardware and communication protocols and may be a direct or an indirect (e.g., networked) connection.

Generally speaking, and depending on the particular system in question, devices to which the system 200 connects include one or more input devices to allow data to be input into/received by the system 200 and one or more output device to allow data to be output by the system 200.

By way of example, where the system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g., a mouse, trackpad, or other cursor control device), a keyboard 226, and a speaker device 228.

As another example, where the system 200 is a portable personal computing device, such as a smart phone or tablet, it may include a touchscreen display 218, a camera device 220, a microphone device 222, and a speaker device 228.

As another example, where the system 200 is a server computing device, it may be remotely operable from another computing device via a communication network. Such a server may not itself need/require further peripherals such as a display, keyboard, cursor control device etc. (though may nonetheless be connectable to such devices via appropriate ports).

The system 200 also includes one or more communications interfaces 216 for communication with a network, such as the network 130 of the environment 100. Via the communications interface(s) 140, the system 200 can communicate data to and receive data from networked systems and/or devices.

The system 200 stores or has access to computer applications (which may also be referred to as computer software or computer programs). Generally speaking, such applications include computer readable instructions and data which, when executed by the processing unit 202, configure the system 200 to receive, process, and output data. Instructions and data can be stored on non-transitory machine-readable medium such as 210 accessible to the system 200. Instructions and data may be transmitted to/received by the system 200 via a data signal in a transmission channel enabled (for example) by a wired or wireless network connection over an interface such as the communications interface 216.

Typically, one application accessible to the system 200 will be an operating system application. In addition, the system 200 will store or have access to applications which, when executed by the processing the unit 202, configure the system 200 to perform various computer-implemented processing operations described herein. For example, and referring to the networked environment of FIG. 1 above, the server system 102 includes one or more systems which run a hosting application 104, a data storage application 106, and a data storage 108. Similarly, the client system 110 runs a client application 112.

In some cases, part or all of a given computer-implemented method(s) will be performed by the system 200 itself, while in other cases processing may be performed by other devices in data communication with the system 200.

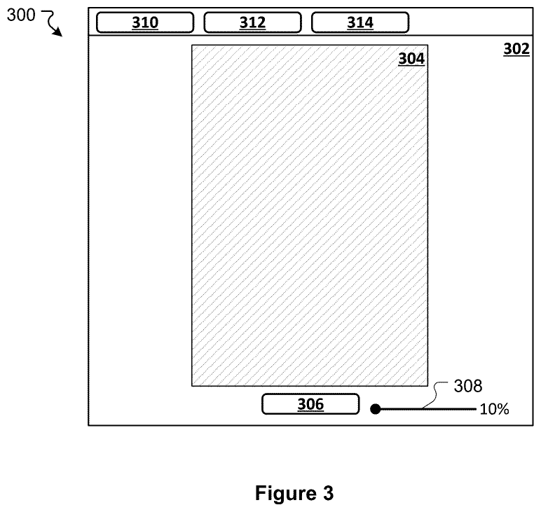

In the present disclosure, the client application 112 configures the client system 110 to provide an editor user interface 300 (UI). Generally speaking, the editor UI 300 will allow a user to create, edit, and output designs. FIG. 3 provides a simplified and partial example of an editor UI. In this example the editor UI 300 is a graphical user interface (GUI).

The editor UI 300 includes a design preview area 302. The preview area 302 may, for example, be used to display a page 304 (or, in some cases multiple pages) of a design that is being created and/or edited. In this example an add page control 306 is also provided (which, if activated by a user, causes a new page to be added to the design being created) and a zoom control 308 (which a user can interact with to zoom into/out of page currently displayed).

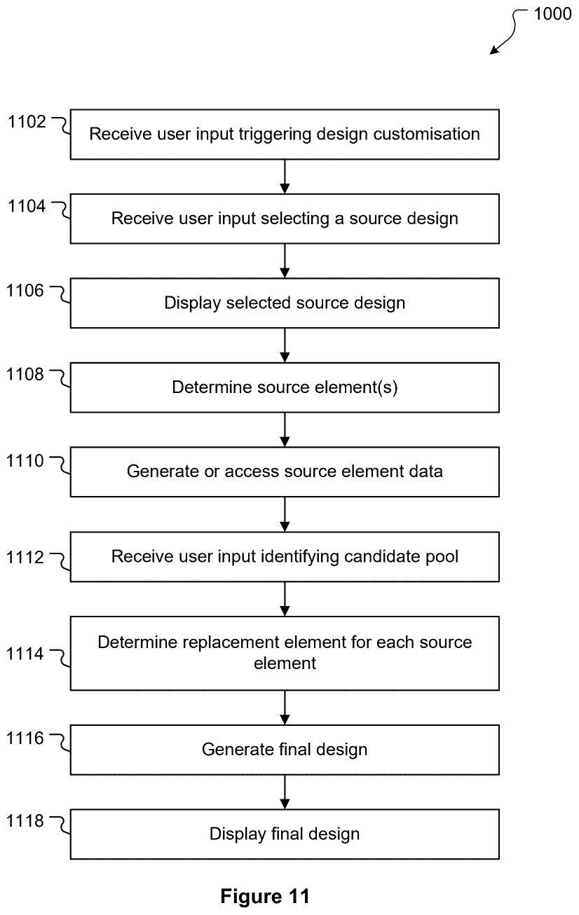

The GUI 300 of the present example includes a design customisation control 310, an asset replacement control 312, and an identify element collections control 314. These controls are described further below with reference to FIGS. 11, 12, and 13 respectively.

Data in respect of designs that have been (or are being) created or modified may be stored in various formats. An example design data format that will be used throughout this disclosure for illustrative purposes will now be described. Alternative design data formats (which make use of the same or alternative design attributes) are, however, possible, and the processing described herein can be adapted for alternative formats.

In the present context, data in respect of a particular design is stored in a design record. Generally speaking, a design record defines certain design-level attributes and includes page data.

A design's page data defines (or references) one or more page records. Each page record defines a page of the design via one or more page-level attributes and element data.

In the present example, the format of each design record is a device independent format comprising a set of key-value pairs (e.g., a map or dictionary). To assist with understanding, a partial example of a design record format is as follows:

| Attribute | Example |
|---|---|
| Design ID | “designId”: “abc123” |
| Dimensions | “dimensions”: {“width”: 1080, “height”: 1080} |
| Design type | “type”: “poster” |
| Design name | “name”: “Test Doc 3” |
| Design owner | “owner”: 12ab34cd |
| Edit time | “edited”: “xxx” |
| Page data | “pages”: [{page 1}, . . . {page n}] |

In this example, the design-level attributes include: a design identifier (which uniquely identifies the design); page dimensions (e.g., a default page width and height); a design type (e.g., an indicator of the type of the design, which may be used for searching and/or sorting purposes); a design name (e.g., a string defining a default or user specified name for the design); a design owner (e.g., an identifier of a user or group that owns or created the design); a most recent edit time (e.g., a timestamp indicating when the design was last edited); and page data (discussed below). Additional and/or alternative design-level attributes may be provided, such as attributes regarding creation date, design version, design permissions, and/or other design-level attributes.

In this example, a design record's page data is a set (in this example an array) of page records, each of which defines page data in respect of a page of the design. In this example, a page record's position in a design's page array serves to identify the page and also determines its position in the design (e.g., a page at array index n appears after a page at array index n−1 and before a page at array index n+1). Page order may be alternatively handled, however, for example, by storing page order as an explicit attribute.

To assist with understanding, a partial example of a page record format is as follows:

| Attribute | Example |
|---|---|
| Dimensions | “dimensions”: {“width”: 1080, “height”: 1080} |
| Background | “background”: {“mediaID”: “M12345”} |
| Element data | “elements”: [{element 1}, . . . {element n}] |

In this example, the page-level attributes include: dimensions (e.g., a page width and height which, if present, override the default page dimensions defined by the design level dimensions attribute described above); background (data indicating any page background that has been set, for example an asset identifier of an image that has been set as the page background, a value indicating a particular colour of a solid background fill, or data indicating an alternative background); and element data (discussed below). Additional and/or alternative page-level attributes may be provided.

In this example, a design page's element data is a set (in this example an array) of element records. Each element record defines an element that has been added to the page. In this example, an element record's position in a page's elements array serves to identify the element and also determines the depth or z-index of the element on the page (e.g., an element at array index n is positioned above an element at array index n−1 and below an element at array index n+1). Element depth may be alternatively handled, however, for example, by storing depth as an explicit element attribute.

Generally speaking, an element record defines an object that has been added to a page—e.g., by copying and pasting, importing from one or more asset libraries (e.g., libraries of images, animations, videos, etc.), drawing/creating using one or more design tools (e.g., a text tool, a line tool, a rectangle tool, an ellipse tool, a curve tool, a freehand tool, and/or other design tools), or by otherwise being added to a design page.

Different types of design elements may be provided for depending on the system in question. By way of example, design element types such as the following may be provided: image elements; graphic elements; video elements; audio elements; text elements; and/or elements of other types.

As will be appreciated, different attributes may be relevant to different element types. For example, any element that holds visual media (e.g., an image, video, text, etc) will typically be associated with position and size data, while such data may not be relevant to an element that holds audio media. Accordingly, different element record formats (with different attributes) may be used for different element types.

By way of example, an element record for an image (e.g., a raster image) type element may be as follows:

| Attribute | Note | E.g. |
|---|---|---|
| Type | A value defining the type of the element. | “type”: “IMAGE”, |
| Position | Data defining the position of the element: | “position”: (100, 100) |
| | e.g., an (x, y) coordinate pair defining (for | |
| | example) the top left point of the element. | |
| Size | Data defining the size of the element: e.g., a | “size”: (500, 400) |
| | (width, height) pair. | |
| Rotation | Data defining any rotation of the element. | “rotation”: 0 |
| Opacity | Data defining any opacity of the element (or | “opacity”: 1 |
| | element group). | |
| Media | Data indicating the media (e.g., an image) | “mediaID”: “M12345” |
| identifier | that the element holds/is used to display | |

In the description below element bounding boxes are referred to. An element's bounding box can, for example, be defined by a set of four values: a minimum Y coordinate (e.g., the element's y position); a minimum X coordinate (e.g., the element's x position); a maximum Y coordinate (e.g., the element's Y position plus its height); and maximum X coordinate (e.g., the element's X position plus its width).

The storage location for design data (e.g., design records) will depend on implementation. For example, in the networked environment described above design records are (ultimately) stored in/retrieved from the server environment's data storage 108. This involves the client application 112 communicating design data to the server environment 102—for example to the server application 104 which stores the data in data storage 108, e.g., through the services of the data storage application 106. Alternatively, or in addition, design data may be locally stored on a client system 112 (e.g., in non-transitory memory 210 thereof).

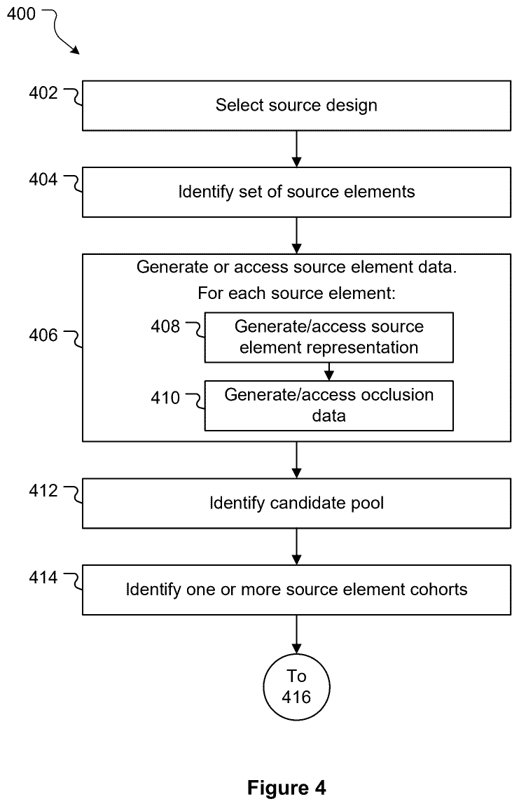

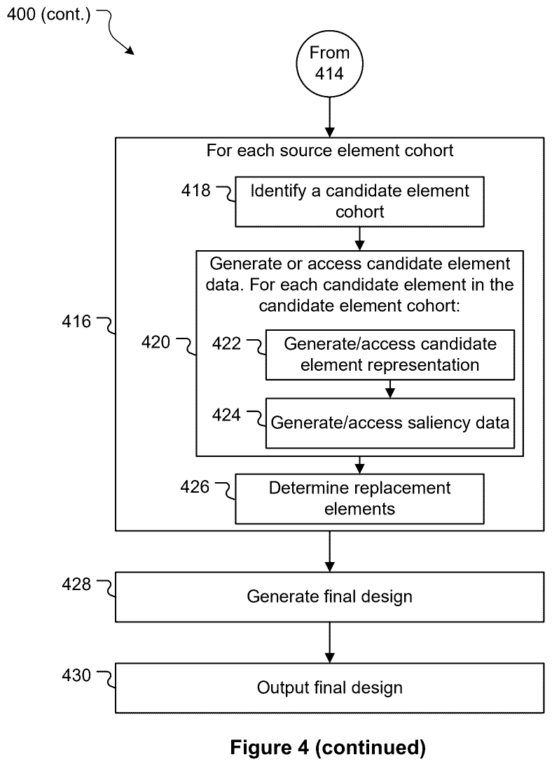

Turning to FIG. 4, a computer-implemented method 400 for generating a design based on a source design will be described. The steps of method 400 are described as being performed by the hosting application 104 or the client application 112. As noted above, however, this is by way of example and in certain cases a step described as being performed by one application could alternatively be performed by a different application.

The embodiments of the present disclosure are generally described in the context of identifying replacement elements for, and replacing, image type design elements. In the present disclosure reference to an image type element is reference to an element that is, or is associated with media that is, a raster image. For example, in the context of the element record example provided above, an element that has media that is a raster image is an image type design element.

The techniques described herein can, however, be applied (or be adapted to be applied) to elements that are or have media of other types. As one example, the techniques described may be applied to graphic (e.g., vector graphic) type elements by rasterising the graphic elements to create raster versions thereof. As another example, the techniques may be applied to video type elements by performing the processing described (or adaptations thereof) on a representative frame of a video (which will or can be converted to a raster image).

At step 402, a source design is selected for processing. The method 400 may be invoked in various contexts and the manner in which a source design is selected at step 402 may vary depending on the context.

As one example, method 400 may be invoked to customise one or more existing designs (such as design templates or other existing designs) as described earlier. In this context, a set of one or more existing designs that are to be processed may be identified manually by a user, e.g. via a user interface provided by client application 112 that allows a user to search or browse for, and select, designs for customisation (an example of this is described below with reference to FIG. 11). Alternatively, the set of one or more existing designs may be automatically identified by another process or application (executing, for example, on hosting application 104). Each of those existing designs may then be selected (in turn or in parallel) as a source design for processing according to method 400.

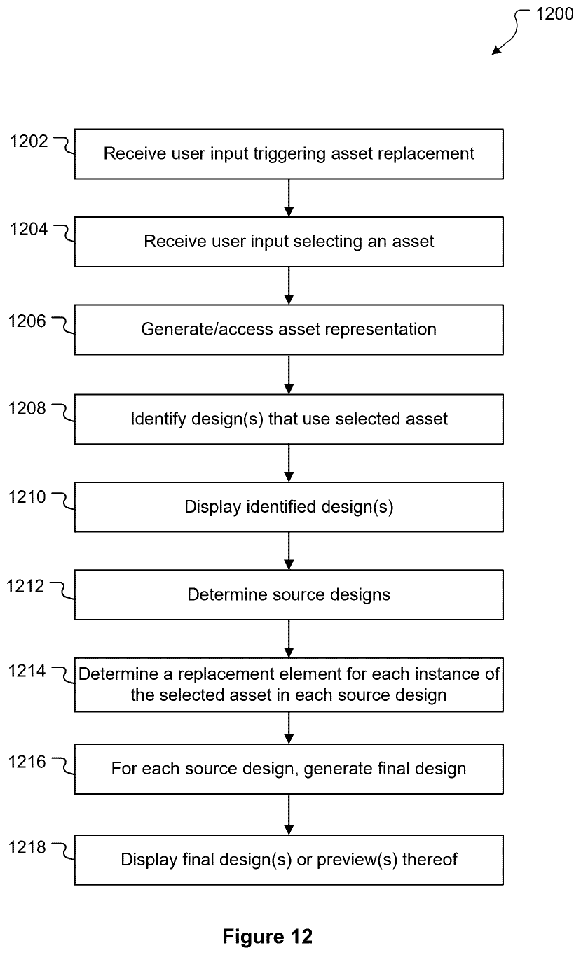

By way of further example, method 400 may be invoked as part of an asset replacement process as described above. In this context, and as one example, a user may use the client application 112 to select a particular design asset. Following this, and as described below with reference to FIG. 12, designs that include an instance of the selected asset are identified and then each design may be processed in turn (or in parallel) to replace the instance(s) of the selected asset(s).

At step 404, the hosting application 104 processes the source design to identify a set of one or more source elements (each source element being a design element of the source design).

If the source design includes multiple distinct pages various approaches for processing the design (and identifying source elements) are possible. In one embodiment, if the source design is a multi-page design it is processed as a whole and the set of source elements identified at 404 includes all source elements from all pages of the source design. In alternative embodiments, if the source design is a multi-page design each page of the source design may be treated separately. In this case, each page of the source design is processed separately at 404 to identify a set of source elements (and the remaining processing of method 400 is adapted to be performed separately for each page of the design and its set of source elements).

Source elements for inclusion in the set of source elements may be identified in various ways, examples of which are provided below. It will be appreciated that one or a combination of techniques for identifying source elements may be used.

In certain embodiments, hosting application 104 may be configured to process the source design to automatically identify source elements based on one or more source element criteria. A source element criterion may, e.g., specify the type of suitable or desired source elements to be identified. Such a criterion may, for example, result in all image elements of the source design being included in the set of source elements. It will be appreciated that other or additional source element criteria are possible.

In addition, or alternatively, the hosting application 104 may be configured to process the source design using a machine learning (ML) model that is trained to identify source elements of a design—that is, elements that are appropriate for replacement. For example, in a design customisation process a ML model that has been trained to identify elements of the source design that do not require replacement, e.g., because such elements do not contain material relevant to customisation (e.g., specific text, logos, elements that contribute to the layout of a design, and/or other types of elements that should not be replaced in a design customisation process) may be used. In this case, any elements that are not identified by the trained ML model are treated as source elements.

In addition, or alternatively, the hosting application 104 may be configured to automatically identify source elements based on an attribute associated with each source design element. For example, each element record of a source design may include an attribute that indicates whether or not it is an element that should be replaced in a design customisation process.

In addition, or alternatively, source elements may be manually selected (or deselected) by a user. For example, client application 112 may display the source design in a preview area (such as area 302 of UI 300) and a user may select/deselect specific elements of the source design as source elements (e.g., by clicking on or contacting the elements or otherwise selecting/deselecting them).

If, at step 404, no source elements are identified, the selected source design cannot be used to generate a new design according to the method 400. In this case, the method 400 terminates. In certain contexts (e.g., where a user has manually selected the source design), the client application 112 may cause an error message to be displayed (e.g., a message indicating the source design cannot be used and asking the user to select an alternative source design).

At step 406, the hosting application 104 generates or accesses source element data for each source element in the set of source elements. Generally speaking, the source element data for a particular source element is data that is used to identify a replacement element for that source element.

In the present embodiment, step 406 includes generating or accessing one or more source element representations for each source element at 408. In certain embodiments, generating or accessing source element data also includes generating or accessing occlusion data for each source element at 410.

In some instances, the source element data for a selected source element may previously have been generated and stored. In this case, the hosting application 104 accesses the source element data for the selected source element at 408 (and/or at 410 if occlusion data is being used). Source element data may, for example, be stored as attributes of the source element's element record and accessed from data storage 108. In other instances, the source element data for a selected source element will not be available. In this case, the hosting application 104 generates the source element data at 408 (and/or at 410 if occlusion data is being used). Where hosting application 104 generates source element data it may also store the source element data for future use.

At 408, hosting application 104 generates or accesses a source element representation for each source element. The source element representation for a source element is based on that source element's media or content. For example, for image-type elements the source element representation is generated based on the actual image that the source element is associated with.

In the present embodiment, a single source element representation is generated or accessed for each source element. This single source element representation is data (e.g. an embedding or other data) that captures information in respect of both the semantic content of the source element's media. In the present embodiment, the single source element representation also captures information in respect of a style of the source element's media.

The processing performed to generate such a source element representation will depend on the type of the source element. For example, in the context of image-type source elements (or other types of elements for which raster images have been generated, such as graphic elements or video elements as described above) a multi-modal embedding model may be used. By way of specific example, a Contrastive Language-Image Pre-training (CLIP) embedding may be generated based on the element's image and used as a singular source representation that encodes both content and style information. Generally speaking, CLIP embeddings are considered a suitable representation for multimodal reasoning. In other embodiments, alternative pre-trained machine learning models may be used to generate a source element representation or a machine learning model may be specifically developed and trained to do so.

In alternative embodiments, multiple source element representations may be generated (or accessed) for each source element at step 408. For example, and continuing in the context of image type elements, a source element's image may be processed using one machine learning model to generate a first embedding (e.g. a semantic content embedding) and a separate machine learning model to generate a second embedding (e.g. a style embedding). If more than one representation is generated for each source element, such representations may be used separately or combined to represent the element.

If method 400 is to be used (or adapted to be used) to identify replacement elements for non-image type elements, different element representations (and different approaches to generating those representations) may be appropriate. For example, if a source element is a video, rather than generating a representation for that element based on a single frame, a representation may be generated by using a machine learning model that is trained to process an entire video and generate an embedding that captures the sematic content and/or style of the video as a whole. Examples of ML architectures that may be appropriate for generating video embeddings include 3D Convolutional Networks and Video Vision Transformer (ViViT). Similarly, if a source element is an audio clip, a representation may be generated by using a machine learning model that is trained to process an audio clip and generate an embedding that captures the sematic content and/or style of the audio clip. Examples of ML architectures that may be appropriate for generating audio clip embeddings include Wav2Vec and HuBERT. As yet a further example, if a source element is an animated element (e.g. an animated gif or the like) a representation may be generated by using a machine learning model that is trained to process such an animated element and generate an embedding that captures the sematic content and/or style thereof.

In certain embodiments, if the hosting application 104 generates one or more source element representations for a selected source element at 408 it also stores the source element representation(s). For example, application 104 may store source element representation(s) as one or more attributes of the selected source element's element record (or as other metadata associated with the source element)—e.g.:
“representation”: <string>;

Storing representation data (and/or element-overlay data as described below) for a source element may be appropriate, for example, if source designs are being prepared in advance and/or may be used in future design generation processes. This may be the case, e.g., in a template customisation/localisation process where the same template may be customised/localised multiple times and storing source element data prevents having to determine this data again in the future uses of the source design.

In certain embodiments, hosting application 104 also generates or accesses occlusion data for each source element at 410. Occlusion data for a selected source element is data that indicates any regions of the selected source element that are overlaid (e.g., occluded) by other elements of the source design. Such regions will be referred to as occlusion regions.

Occlusion regions for a given source element can be identified in various ways and based, for example, on the bounding boxes and depths (or z-indexes) of the source design's elements.

In the present embodiment, in order to identify any occlusion regions for a selected source element the host application 104 determines any source design elements that are above (e.g., have a higher z-index than) the selected source element. For each source design element that is above the selected source element, application 104 then determines whether that element is an occluding element—that is, an element that partially or wholly overlies (and occludes) the selected source element. This determination is based on the bounding boxes of the two elements. Where an occluding element is identified for a selected source element, application 104 determines the occlusion region—that is, the region that the selected source element and the overlying element intersect.

In some embodiments, if the hosting application 104 generates occlusion data at 410 it also stores the occlusion data. For example, application 104 may store occlusion data for a selected source element as an attribute of the source element's element record (or as other metadata associated with the source element)—e.g.:
“occlusionRegions”: [(minx, maxX, minY, maxY), . . . , (minx, maxX, minY, maxY)]

In this example, each tuple indicates one element occlusion region and includes minX/maxX/minY/maxY values that indicate the corners of the occlusion region. In alternative embodiments occlusion regions may be defined by a set of x, y, width, height (or other) values.

Step 410 operates to determine any areas of a source element that are occluded by other elements. Accordingly, if multiple elements occlude the selected source element, such occlusion may affect different regions of the source element. In some cases multiple element occlusion regions may be combined to identify a larger occlusion region that is created by multiple occluding elements.

In some embodiments, the element occlusion regions (if any) for a selected source element are determined based on all other elements of the source design. In other embodiments, element occlusion regions are determined based on a subset of source design elements. For example, the hosting application 104 may be configured to identify only regions of the source element that are occluded by other elements of a specific type (e.g., text elements). In other embodiments, certain occlusion regions may be disregarded based on attributes of the source element and/or an occlusion element. For example, an occlusion region may be disregarded if the occluding element is transparent, has a transparency attribute that exceeds a certain threshold, or has a transparent (or partially transparent) region where the occluding element overlies the selected source element.

At step 412 the hosting application 104 identifies a candidate pool of elements relevant to the set of source elements. The candidate pool is a set of design elements from which candidate—and ultimately replacement—elements will be selected (as described below). A candidate element is an element that can potentially replace a source element.

The candidate pool may be identified in various manners. In some embodiments, the candidate pool is a predefined set or library of elements. For example, the pool may include all stock images that are available to the hosting application 104 or to a user of the client application 112. Other sets or libraries of elements of one type of element or a combination of element types are possible.

In alternative embodiments, a user may manually select the candidate pool. For example, the client application 112 may cause a pool selection interface to be displayed that allows a user to search/browse for and select one or more folders (e.g., local or remote directories or other element sources) and/or select individual elements (e.g., image files). All elements directly selected and/or a selected folder may then be included in the candidate pool. In some embodiments, further filtering of such elements based on parameter data may be performed as described below.

In still further embodiments, a candidate pool is selected based on parameter data, which defines one or more parameters assessed against all design elements (i.e., the set or library of elements, or elements selected by the user as described above). If an element does not meet the relevant parameters, it is not included the candidate pool. Various examples of such parameters are possible. For example, for image-type elements a threshold resolution may be set, in which case any elements that do not meet that resolution will be included in the candidate pool.

At step 414, the hosting application 104 identifies one or more source element cohorts based on cohort criteria and source element attributes. Each source element cohort includes or is associated with one or more source elements.

Various element cohort criteria may be used to identify source element cohorts. For example, hosting application 104 may be configured to identify source element cohorts based on an aspect ratio criterion: that is, all source elements that have a common aspect ratio are included in (or associated with) a source element cohort. In this case, and for example, if the set of source elements included two elements with a 3:4 aspect ratio, three elements with a 4:5 aspect ratio, and one elements with a 1:1 aspect ratio, three source element cohorts would be identified: a first cohort including the two 3:4 elements; a second cohort including the three 3:4 elements; and a third cohort including the 1:1 element. In applying an aspect ratio criterion the hosting application 104 may be configured to require source elements to have the same (identical) aspect ratio in order to determine they have a common aspect ratio and belong to the same source element cohort. Alternatively, the hosting application 104 may be configured to allow some difference in aspect ratio and determine that source elements have a common aspect ratio if their aspect ratios are within a threshold distance of one another.

As another example, hosting application 104 may alternatively (or additionally) be configured to identify source element cohorts based on a colour criterion: for example elements determined to be black and white (or greyscale) may be assigned to a different cohort (or multiple different cohorts if additional cohort criteria are being applied) than elements determined to be colour.

In alternative embodiments, hosting application 104 may be configured to add all source elements to a single cohort without applying any cohort criteria. In this case, and as will be appreciated, step 414 may be omitted and the operations of step 416 performed on the set of source elements as a whole.

At step 416, the hosting application 104 processes each source element cohort separately to determine a set of replacement elements for each source element cohort. In the present embodiment this involves steps 418 to 426.

At step 418, the hosting application 104 identifies a candidate element cohort for the source element cohort that is being processed. The candidate element cohort includes elements from the candidate pool (identified at 412) and is the set of elements that replacement elements for the source elements in the selected source element cohort will be selected from.

In the present embodiment, hosting application 104 identifies the candidate element cohort for the selected source element cohort at 418 based on the same cohort criteria that were used to identify the selected source element cohort.

For example, if the selected source element cohort was identified based on aspect ratio (and includes source elements of a particular aspect ratio), then the candidate element cohort identified for that source element cohort will also be identified based on aspect ratio. For example, if the selected source element cohort includes source element with a particular aspect ratio (e.g. 3:4), then the candidate element cohort identified for that source element cohort will include candidate elements from the candidate pool that have an aspect ratio that matches that particular aspect ratio. In some embodiments, the hosting application 104 may be configured to require aspect ratios to be identical to determine a match. In other embodiments, the hosting application 104 may be configured to permit a tolerance (i.e., aspect ratios are determined to match if they are within a predefined threshold of one another).

If source element cohorts are not identified at 414 (or all source elements are included in a single cohort without reference to cohort criteria) step 418 may be omitted (or the entire candidate pool may be considered as the candidate element cohort).

At step 420, the hosting application 104 generates or accesses candidate element data for each candidate element in the candidate element cohort identified at step 418. The candidate element data is generated or accessed at 420 in order to allow candidate elements to be compared with source elements. Accordingly, the candidate element data that is generated or accessed will correspond to the source element data that is generated or accessed at 406. In the present embodiment, step 420 includes generating or accessing one or more candidate element representations for each candidate element at 422. In certain embodiments, and if occlusion data is generated or accessed for source elements at 406, generating or accessing candidate element data also includes generating or accessing saliency data for each candidate element at 424.

In some instances, the candidate element data for a selected candidate element may previously have been generated and stored. In this case, the hosting application 104 accesses the candidate element data for the selected candidate element at 422 (and/or at 424 if saliency data is being used). Candidate element data may, for example, be stored as attributes of the candidate element's element record and accessed from data storage 108. In other instances, the candidate element data for a selected candidate element will not be available. In this case, the hosting application 104 generates the candidate element data at 422 (and/or at 424 if saliency data is being used). Where hosting application 104 generates candidate element data it may also store the candidate element data for future use.

At 422, hosting application 104 generates or accesses one or more candidate element representations for each candidate element. The one or more candidate element representations are originally generated to allow comparison between a candidate element (via its representation(s)) and a source element (via its representation(s)). Typically, therefore, candidate element representations are generated in the same way that source element representations are generated at 408.

For example, if a singular source element representation (e.g., a CLIP embedding) is generated (or accessed) for each source element at 408, then a singular comparable candidate element representation (e.g., a CLIP embedding) will be generated (or accessed) for each candidate element at 422. Alternatively, if multiple source element representations are generated (or accessed) for each source element at 408 (e.g., a content representation and a style representation), then multiple comparable candidate element representations will be generated (or accessed) for each candidate element at 422.

In some embodiments, if the hosting application 104 generates one or more candidate element representations for a selected candidate element at 422 it also stores the candidate element representation(s). For example, application 104 may store candidate element representation(s) as one or more attributes of the selected candidate element's element record (or as other metadata associated with the candidate element)—e.g.:
“representation”: <string>;

Storing representation data (and/or saliency data as described below) for a candidate element may be appropriate, for example, if candidate elements are being prepared in advance and/or may be reused in future design generation processes.

In certain embodiments, hosting application 104 also generates or accesses saliency data for each candidate element at 424. Saliency data for a selected candidate element is data that indicates the salient region(s) or point(s) of the selected candidate element.

Salient regions or points of a given candidate element can be identified in various ways. For example, hosting application 104 may process the selected candidate element using a machine learning model that has been trained to detect salient objects (or salient regions) in images. The trained machine learning model may, for example, a convolutional neural network or a residual network trained to perform pixel classification. By way of more specific example, a pre-trained U2-Net model as generally described in the paper “U2-Net: Going Deeper with Nested UStructure for Salient Object Detection” by Xuebin Qin, Zichen Zhang, Chenyang Huang, Masood Dehghan, Osmar R. Zaiane and Martin Jagersand (arXiv: 2005.09007v3) may be used. Alternative approaches for determining salient region(s) may, however, be used.

Depending on the manner in which salient regions are identified, salient region data may initially take the form of a saliency mask—e.g., set of mask values, each of which corresponds to a pixel of the selected candidate element. Where original mask values are values between 0 and 1, these may (though need not) be converted to final mask values of either 1 (indicating that the corresponding candidate element pixel is part of a salient region) or 0 (indicating that the corresponding candidate element is not part of a salient region). This conversion may be performed by applying a threshold to the original mask values, e.g., a threshold of 0.15 (or an alternative threshold value).

In some embodiments, if the hosting application 104 generates saliency data at 424 it also stores the saliency data. For example, application 104 may store saliency data for a selected candidate element as an attribute of the candidate element's element record (or as other metadata associated with the candidate element)—e.g.:
“salientRegions”: [(minx, maxX, minY, maxY), . . . , (minx, maxX, minY, maxY)];

In this example, each tuple indicates one salient region and includes minX/maxX/minY/maxY values that indicate the corners of the salient region (which host application 104 may, for example, determine based on final mask values as described above).

In alternative embodiments, instead of defining/storing saliency data as bounding boxes (per the above example), the hosting application may use a salient region mask as described above to identify the most salient point (or points) in the image, and then use that point as the saliency data)—e.g.:
“salientPoints”: [(x, y), . . . (x,y)];

In this example, each tuple indicates a single x,y position. In some cases a single salient point (x,y coordinate pair) may be determined based on the position of the most salient pixel in a mask as described above. In other cases, more than one salient point may be recorded. This may be appropriate if a saliency mask identifies multiple pixels that have values that are close to the highest saliency value in the mask but are separated by other pixels with lower saliency values (indicating that the high saliency value pixels are part of different salient regions or object rather than being part of the same salient region or object).

At step 426, the hosting application 104 determines a set of replacement elements for the selected source element cohort. The set of replacement elements includes a replacement element for each source element in the selected source element cohort. Each replacement element is selected from the candidate element cohort identified at 418. Replacement elements are identified based on the source element data (generated or accessed at step 406) and the candidate element data (generated or accessed at step 420).

The hosting application 104 may be configured to determine replacement elements at 426 in various ways. Example methods for doing so are described below with reference to methods 500, 600, and 700.

Step 426 results in replacement element data that identifies a replacement element for each source element in the selected source element cohort. Replacement element data may be in any appropriate form. For example, replacement element data may be structured as a set of tuples, with each tuple including a source element (SE) identifier and a replacement element (RE) identifier. For example, for n source elements, the structure may be as:
[(SE₁ id, REₓₓ id), . . . (SEₙ id, RE_{yy} id)];

At step 428, and once replacement elements have been identified for all source element cohorts, the hosting application 104 generates a final design. The final design is generated based on the source design and the replacement elements (determined at 426).

Various approaches to generating a final design are possible, and the appropriate approach will depend on the data structure of the source and final designs and the context in which the method 400 is being performed. For example, in a design customisation process, a new design will typically be generated. This may involve, e.g., creating a copy of the source design (if not already done) and replacing each source element in the copy with its replacement element according to replacement element data. In the context of the design data structure described above, replacing a particular source element may be done by replacing the source element's element record in the elements array with the replacement element's element record.

As another example, in an asset replacement process the existing source design will typically be updated by replacing each source element in the source design with its replacement element. In this case no new design is created.

At step 430, the hosting application 104 outputs the final design.

In some embodiments, the hosting application 104 is configured to send design data corresponding to the final design to the client application 112 which may then display the final design to a user via a UI (e.g., in the preview area 302 of GUI 300).

In some embodiments, the hosting application 104 is configured to save the design data corresponding to the final design to data storage. This may be done, for example, using the services provided by the data storage application 106 to store the data in data storage 108.

In will be appreciated that once a final design has been generated additional and/or alternative operations may be performed, such as publishing the final design in an online web portal, sharing the final design with other applications, etc.

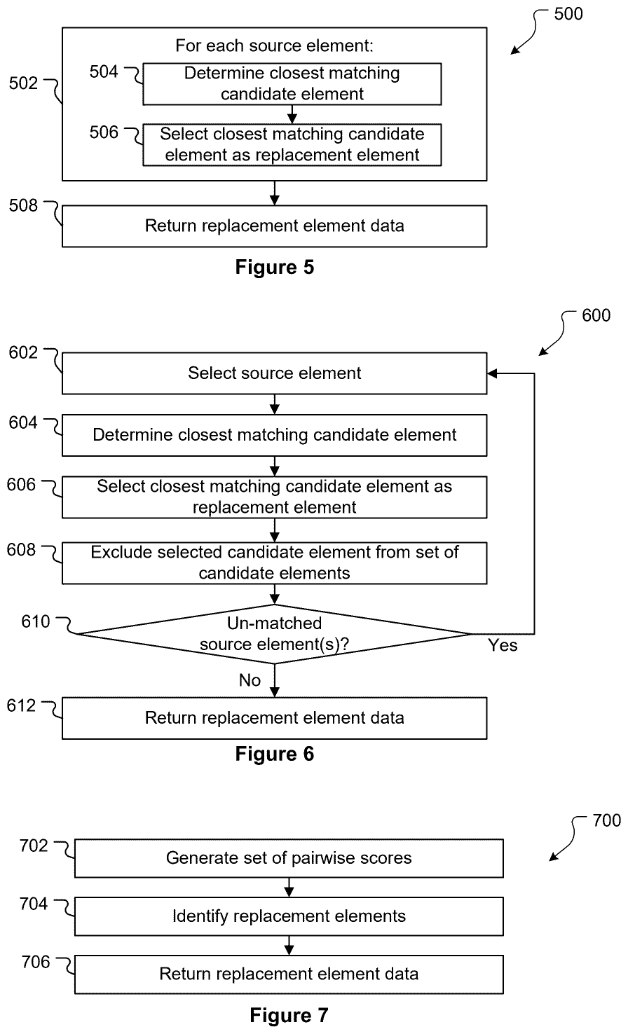

Turning to FIGS. 5, 6, and 7, three different computer-implemented methods (500, 600, and 700) that operate to determine a set of replacement elements for a set of source elements will be described.

Each of methods 500, 600 and 700 is described as being performed by the hosting application 104 running on the server system 102. In alternative embodiments, however, the processing described may be performed by one or more alternative applications running on the client system 110, server system 102, and/or other computer processing systems.

Each of methods 500, 600 and 700 takes as input (or has access to) a set of source elements and a set of candidate elements from which replacement elements are selected.

Methods 500, 600, and/or 700 may, for example, be performed to determine replacement elements at 426 of method 400. In this case, the set of source elements that method 500, 600, or 700 takes as input (or has access to) is a selected source element cohort (in step 416) and the set of candidate elements that method 500, 600, or 700 takes as input (or has access to) is the candidate element cohort identified (at step 418) for that selected source element cohort.

Turning to FIG. 5, method 500 for determining a set of replacement elements for a set of source elements will be described. For ease of reference, method 500 may be referred to as an independent element matching method.

At step 502, the hosting application 104 processes each source element independently to determine a corresponding replacement element. Source elements may be processed in any order or in parallel. This includes steps 504 and 506.

At step 504, the hosting application 104 determines the closest matching candidate element for a selected source element. The closest matching candidate element is selected from the set of candidate elements.

In the present embodiments, source and candidate element representations are vectors (e.g., embeddings). Accordingly, distances between two elements (e.g. a selected source element and a selected candidate element) can be calculated using a distance measure (e.g. cosine distance, Euclidian distance, or an alternative distance measure).

In one implementation, hosting application 104 may be configured to identify a replacement element for a selected source element at 504 by an approximate nearest neighbour (ANN) search/lookup approach.

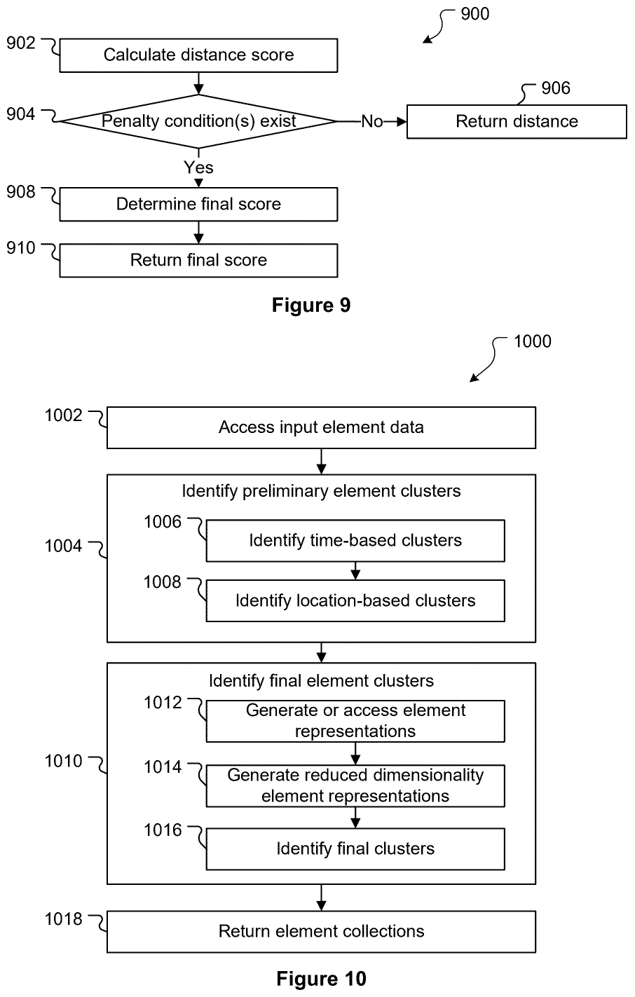

Alternatively, hosting application 104 may be configured to implement an exhaustive approach to determine the replacement element for a selected source element. In this case, for each selected source element the hosting application 104 may calculate scores for that source element each candidate element (e.g. a set of pairwise scores). Each score is based on the distance between the representations of the source and candidate elements in question. In certain embodiments, and as described below with reference to FIG. 9, each score may be further based on one or more penalties. The hosting application 104 then selects the candidate element that is the closest to the source element as its replacement.

As described above, in certain embodiments multiple representations may generated or accessed for each source element (at 408) and each candidate element (at 422). In this case hosting application 104 may be configured to identify the closest matching candidate element for a selected source element by calculating a combined distance measure for each [source element, candidate element] pair and selecting the candidate element that is closest to the selected source element as its replacement. The combined distance measure is calculated based on the element representations, and different weights may be applied. For example, if a first (e.g., content) representation and second (e.g., style) representation are generated or accessed for each source element at 408 and for each candidate element at 422, the combined distance measure may be calculated as:
(a*distance(<source element's first representation>, <candidate element's first representation>))+(b*distance(<source element's second representation>, <candidate element's second representation>))

Where a and b are set to provide the desired weighting between the different representations.

At step 506, the hosting application 104 selects the closest matching candidate element as the replacement element for the selected source element.

Once replacement elements for all source elements have been determined and selected at step 502, at step 508 the hosting application 104 returns replacement element data. As described above, the replacement element data may take various forms, but in one embodiment is a set of tuples with each tuple associating a particular source element with the replacement element identified for it.

The approach of method 500 to identifying replacement elements may be advantageous in certain circumstances. For example, method 500 may be appropriate if the set of source elements (e.g. a source element cohort) includes a single source element.

Turning to FIG. 6, method 600 for determining a set of replacement elements for a set of source elements will be described. In method 600, the hosting application 104 is configured to determine replacement elements in a manner that avoids the same candidate element being selected as a replacement for more than one source element. For ease of reference, method 600 may be referred to as a duplicate avoidance method.

At step 602, the hosting application 104 selects a source element for processing. Source elements may be processed in any order.

At step 604, the hosting application 104 determines the closest matching candidate element for the selected source element. The operations in this step may be the same as, or similar to, those described in relation to the step 504 of method 500.

At step 606, the hosting application 104 selects the closest matching candidate element as the replacement element for the selected source element. The operations in this step may be the same as, or similar to, those described in relation to step 506 of method 500.

At step 608, the hosting application 104 excludes the candidate element selected at step 606 from the set of candidate elements so that it cannot be selected as a replacement element for another source element. This exclusion may be done in a variety of manners, e.g., by removing the candidate element from the set of candidate elements method 600 is operating on, or by setting a flag or other attribute indicating that the candidate element has already been selected as a replacement element and cannot be selected again.

At step 610, the hosting application 104 determines if any source elements have not yet been matched to a candidate element. If so, control returns to step 602 where the next source element is selected. If replacement elements have been identified for all source elements control continues to step 612.

Once replacement elements for all source elements have been determined, at step 612 the hosting application 104 returns replacement element data. This step may be the same as step 508 of method 500.

The approach of method 600 to identifying replacement elements may be advantageous in certain circumstances. For example, method 600 may be appropriate where one or more source element cohorts include multiple source elements and generating a final design that does not include duplicate elements is desirable.

Turning to FIG. 7, method 700 for determining a set of replacement elements for a set of source elements will be described. In method 700, the hosting application 104 is configured to determine replacement elements in a manner that optimises (or improves) the set of replacement elements selected for the set of source elements as a whole. For ease of reference, method 700 may be referred to as an inclusive element matching process.

At step 702, the hosting application 104 generates a set of pairwise scores (e.g., a pairwise score matrix). The set of pairwise scores includes a score for every [source element, candidate element] pair in the input sets of source and candidate elements. That is, for each source element in the input set of source elements, the set of pairwise scores includes scores for that source element and each candidate element in the input set of candidate elements.

For example, consider a scenario in which: the set of source elements input to method 700 is a source element cohort that includes three source elements identified as SE1, SE2, and SE3; and the set of candidate elements input to method 700 is a candidate element cohort that includes four candidate elements identified as CE1, CE2, CE3, and CE4. In this case, the set of pairwise scores may be a matrix such as the following (with labels added for readability):

| | CE1 | CE2 | CE3 | CE4 |
|---|---|---|---|---|
| SE1 | Score_{1, 1} | Score_{1, 2} | Score_{1, 3} | Score_{1, 4} |
| SE2 | Score_{2, 1} | Score_{2, 2} | Score_{2, 3} | Score_{2, 4} |
| SE3 | Score_{3, 1} | Score_{3, 2} | Score_{3, 3} | Score_{3, 4} |

Hosting application 104 calculates each score is based on the distance between the representations of the source and candidate elements in question. In certain embodiments, and as described below with reference to FIG. 9, each score may be further based on one or more penalties.

At step 704, the hosting application 104 processes the set of pairwise scores generated at 702 to identify a replacement element for each source element. In particular, the hosting application 104 is configured to identify replacement elements for the set of source elements as a whole, and in a way that optimises the entire set of replacement elements selected for the set of source elements (rather than any single source element). In the present embodiment, hosting application 104 processes the set of pairwise scores using an assignment problem approach to assign each source element to a candidate element (which becomes that source element's replacement element). In one implementation, hosting application 104 is configured to solve the assignment problem—and identify the set of replacement elements—using a Jonker-Volgenant algorithm approach. In other embodiments, hosting application 104 may use an alternative approach, for a Hungarian algorithm approach, an Auction algorithm approach, a greedy algorithm approach, or an approach based on an alternative algorithm directed to solving the assignment problem.

At step 706, the hosting application 104 returns replacement element data. The operations in this step may be the same as step 508 of method 500.

The approach of method 700 to identifying replacement elements may be advantageous in certain circumstances. For example, method 700 may be appropriate where it is advantageous to improve or optimise the selection of replacement elements for a source element cohort as a whole (without preferencing any specific source element-candidate element matches).

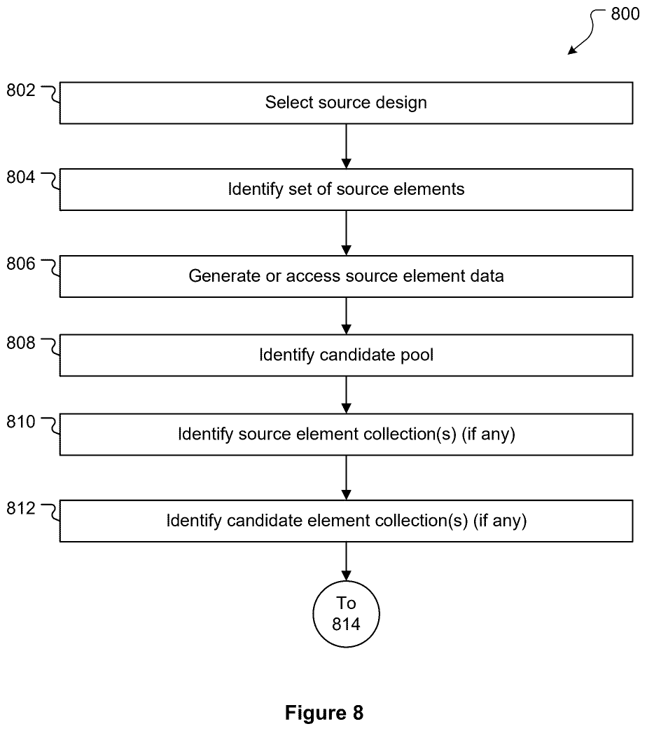

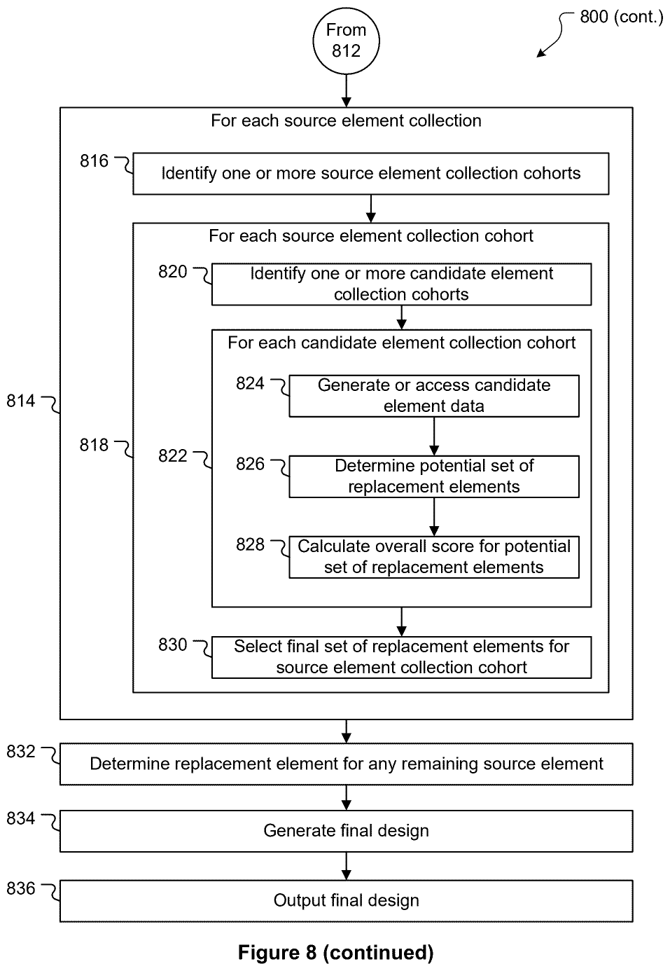

Turning to FIG. 8, another computer-implemented method 800 for generating a design based on a source design will be described. The steps of method 800 are described as being performed by the hosting application 104 or the client application 112. As noted above, however, this is by way of example and in certain cases a step described as being performed by one application could alternatively be performed by a different application.

At step 802, a source design is selected for processing. This step may be the same as (or similar to) step 402 of method 400 described above.

At step 804, the hosting application 104 processes the source design to identify a set of one or more source elements. This step may be the same as (or similar to) step 404 of method 400 described above.

At step 806, the hosting application 104 generates or accesses source element data for each source element in the set of source elements. This step may be the same as (or similar to) step 406 of method 400 described above. For each source element, step 806 includes generating or accessing a source element representation (the same as or similar to step 408 of method 400) and may (though need not) include generating or accessing element occlusion data (the same as or similar to step 410 of method 400).

At step 808, the hosting application 104 identifies a candidate pool of elements relevant to the set of source elements. This step may be the same as (or similar to) step 412 of method 400 described above.

At step 810, the hosting application 104 processes the set of source elements identified at 804 to determine whether any source element collections exist.

In the present disclosure, an element collection (e.g. a source element collection or a candidate element collection as discussed below with reference to step 812) is a set of two or more elements that have a contextual or semantic relationship with one another. For example, where design elements are image elements, a collection may be in respect of a specific photo shooting session (e.g., for a certain event) and include all images taken during that session (and no images not taken during that session). As another example, a collection may be associated with a particular geographic location and include all photos taken at that location. As another example, a collection may be associated with a particular geographic location and a particular time, and include all photos taken at that location in that time period. As another example, a collection may be associated with a particular person or set of people and include all photos that include that person (or set of people) (optionally over a particular time period).

Hosting application 104 may be configured to identify source element collections in various ways.

For example, certain some embodiments the hosting application 104 may be configured to determine that all source elements in the set of source elements are associated with a single source element collection. Such configuration may be based on, for example, an assumption that as the set of source elements come from the same source design there will likely be a relationship between them. Configuration such as this may, for example, be appropriate where the source design is a template that has been prepared (or vetted) and is therefore likely to be high quality and have a consistent/cohesive theme.

By way of alternative example, in some embodiments, the hosting application 104 may determine source element collections based on certain element attributes or metadata. For example, the source elements may be associated with a “collection” attribute that identifies a particular collection that the element is a member of (e.g. “collection”: 1).

As a further alternative example, in some embodiments the client application 112 may display a UI allowing a user to manually associate source elements with different collections—e.g. by selecting source elements and adding them to (or removing them from) a collection.

As a further alternative example, in some embodiments the hosting application 104 may process the set of source elements according to an automatic collection identification method such as method 1000 described below with reference to FIG. 10.

If no source element collections are identified at 810, hosting application 104 may be configured to determine that the entire set of source elements identified at 804 belong to a single collection. Alternatively, if no source element collections are identified at 810, instead of continuing with steps 812 to 836 of method 800, hosting application 104 may instead continue processing according to steps 414 to 430 of method 400. (Phrased alternatively, if no source element collections exist method 400 may be performed instead of method 800).

If one or more source element collections are identified, each source element collection will be associated with two or more source elements. Furthermore, in this case there may be one or more remaining source elements (that is, source elements that do not belong to any collection).

At step 812, the hosting application 104 processes the candidate element pool identified at 808 to determine whether any candidate element collections exist. Hosting application 104 may be configured to determine candidate element collections in various ways, for example in the same (or a similar) meant to which source element collections are identified as described above.

For example, hosting application 104 may be configured to: determine that all candidate elements in the candidate element pool belong to a single collection (which may be appropriate depending on how the candidate element pool is identified); determine candidate element collections based on certain element attributes or metadata (which may include an explicit “collection” attribute that indicates a collection that each candidate element belongs to); cause the client application 112 to display a UI that allows a user to manually associate candidate elements with different collections; process the candidate elements according to an automatic collection identification method such as method 1000 described below with reference to FIG. 10.

If no candidate element collections are identified at 812, the hosting application 104 may be configured to determine that all candidate elements in the pool identified at 806 belong to a single collection. Alternatively, if no candidate element collections are identified at 812, instead of continuing with steps 814 to 836 of method 800, hosting application 104 may instead continue processing according to steps 414 to 430 of method 400. (Phrased alternatively, if no source element collections exist method 400 may be performed instead of method 800).

If one or more candidate element collections are identified, each candidate element collection will be associated with two or more candidate elements. Furthermore, in this case there may be one or more remaining candidate elements (that is, candidate elements that do not belong to any collection).

At step 814, the hosting application 104 processes each source element collection to identify a set for replacement elements for that collection. This involves steps 816 and 818.

At step 816, and for a selected source element collection, hosting application 104 identifies one or more source element cohorts within the selected source element collection (referred to source element collection cohorts). The processing performed at step 816 may be the same as (or similar to) the processing performed at step 414 of method 400, excepting that only cohorts within the selected source element collection are identified.

At step 818, the hosting application 104 processes each source element collection cohort identified for the selected source element collection to identify a set of replacement elements. This involves steps 820, 822, and 830.

At step 820, the hosting application 104 identifies one or more candidate element collection cohorts for the selected source element collection cohort. The processing performed at step 820 is similar to the processing performed at step 418 of method 400, excepting that cohorts are identified from the candidate element collections identified at 812 (rather than the candidate element pool as a whole).

At step 820, and in the present embodiment, the hosting application 104 is configured to process each candidate element collection (identified at 812) to attempt to identify a candidate element cohort that corresponds to the selected source element collection cohort.

To illustrate this consider the following example scenario where:
two source element collections (SE 1 and SE 2) are identified at 810;
two candidate element collections (CE 1 and CE 2) are identified at 812;
the first source element collection (SE 1) is selected for processing at 814;
a first source element collection cohort (SE 1.A) is identified at 816 and includes multiple source elements that have a particular (e.g. 5:6) aspect ratio;
the first source element collection cohort (SE 1.A) is selected for processing at 818;
two candidate element collection cohorts are identified for the first source element collection cohort at 820:
   a first candidate element collection cohort (CE 1.A) is identified that includes candidate elements from the first candidate element collection that match the particular (e.g. 5:6) aspect ratio; and
   a second candidate element collection cohort (CE 2.A) is identified that includes candidate elements from the second candidate element collection that match the particular (e.g. 5:6) aspect ratio.

At step 822, the hosting application 104 processes each candidate element collection cohort identified for the selected source element collection cohort. This involves steps 824, 826, and 828.

At step 824, the hosting application 104 generates or accesses candidate element data for each candidate element in the selected candidate element collection cohort. For each candidate element this step may be the same as (or similar to) step 420 of method 400 described above. For each candidate element, step 824 includes generating or accessing a candidate element representation (the same as or similar to step 422 of method 400) and may (though need not) include generating or accessing saliency data (the same as or similar to step 424 of method 400).

At step 826, the hosting application 104 determines a potential set of replacement elements for the selected source element collection cohort from the selected candidate element collection cohort. This step may be the same as (or similar to) step 426 of method 400 described above. Determining the potential set of replacement elements at 826 may, for example, be performed according to method 500, 600, or 700 described herein. In this case, the set of source elements that is input to method 500, 600, or 700 will be the currently selected source element collection cohort and the set of candidate elements that is input to method 500, 600, or 700 (and from which replacement elements are selected) will be the currently selected candidate element collection cohort.

At 828, the hosting application 104 is configured to calculate an overall score for the potential set of replacement elements determined at 826. This overall score provides a measure of how well (or how poorly) the potential set of replacement elements is for the selected source element collection cohort.

In the present embodiment, each [source element, replacement element] pair in the potential set of replacement elements is associated with a score (calculated, for example, at 504 of method 500, 604 of method 600, or 702 of method 700). In this embodiment, therefore, hosting application 104 calculates the overall score for the potential set of replacement elements based on the distance scores of the [source element, replacement element] pairs in the potential set of replacement elements. For example, hosting application 104 may calculate the overall score by summing the individual scores together.

At 830, and once all candidate element collection cohorts that were determined for the selected source element collection cohort have been processed, hosting application 104 selects a final set of replacement elements for the selected source element collection cohort. This selection is based on the overall scores calculated for each candidate element collection cohort at 828. For example, and depending how the scores are calculated, the hosting application 104 may select the potential set of replacement elements that is associated with the smallest overall score.

To further illustrate the operation of method 800, consider the following example scenario (which extends the example scenario above):
per the above example scenario, the first source element collection cohort (SE 1.A) is selected for processing at 818 and two candidate element collection cohorts are identified for the that source element collection cohort at 820: (CE 1.A) (with elements from the first candidate element collection) and (CE 2.A) (with elements from the second candidate element collection);
in a first processing loop of 822 the first candidate element collection cohort (CE 1.A) is selected for processing which leads to:
   a first potential set of replacement elements being determined for (SE 1.A) at 826 (the replacement elements taken from the first candidate element collection cohort (CE 1.A)); and
   an overall score associated with that first potential set of replacement elements being calculated at 828;
in a second processing loop of 822 the second candidate element collection cohort (CE 2.A) is selected for processing which leads to:
   a second potential set of replacement elements being determined for (SE 1.A) at 826 (the replacement elements taken from the second candidate element collection cohort (CE 2.A)); and
   an overall score associated with that second potential set of replacement elements being calculated at 828;
at 830, either the first or second potential set of replacement elements is selected for the first source element collection cohort (SE 1.A) based on their overall scores.

Once all source element collections have been processed (and final sets of replacement elements identified for those collections at 830) processing proceeds to 832. At 832, the hosting application 104 determines replacement elements for any remaining source elements. As noted above, a remaining source element in this context is a source element that does not belong to any source element collection. If there are no remaining source elements step 832 is not performed.

Hosting application 104 may determine replacement elements for any remaining source elements in various ways.

For example, if there is a single remaining source element hosting application 104 may determine a replacement element according to method 500. Alternatively, if there are multiple remaining source elements the hosting application 104 may determine replacement elements according to method 600 or method 700. When determining replacement elements according to method 500, 600, or 700 hosting application 104 may use the candidate pool identified at 808 as the input set of candidate elements for method 500, 600 or 700. Alternatively, hosting application 104 may filter the candidate pool identified at 808 to remove (or flag) any candidate element that has already been selected as a replacement element from the candidate pool. This will prevent a candidate element that has already been selected to replace a source element from being selected to replace another source element.

At step 834, the hosting application generates a final design. This step may be the same as (or similar to) step 428 of method 400 described above, with the final design being generated based on the source design and the replacement elements as determined at 830 and/or 832.

At step 836, the hosting application outputs the final design. This step may be the same as (or similar to) step 430 of method 400 described above.

As described above, determining replacement elements involves calculating scores for specific [source element, candidate element] pairs—for example at operations 504, 604, and 702 of methods 500, 600, and 700 respectively. As also described above, in certain embodiments the scores calculated for source/candidate element pairs may be based on one or more penalties.

Turning to FIG. 9, a method 900 for calculating a score that can be used to compare two elements (e.g. a source element and a candidate element) will be described. In the present embodiment, method 900 takes as input (or has access to) a source element and a candidate element. Method 900 may be used to calculate a score for a particular [source element, candidate element] pair at step 504 of method 500, at step 604 of method 600, and/or at step 702 of method 700. In each of these specific examples the score that is calculated is then used to determine whether the candidate element of the pair will be selected to replace the source element of the pair.

The processing of method 900 will be described as being performed by the hosting application 104, however may be performed by an alternative application.

At 902, and if not already done, the hosting application 104 calculates a distance score for the source element and candidate element. The distance score is calculated using a distance measure and is based on the source element representation(s) (as generated or accessed at 408) and the candidate element representation(s) (as generated or accessed at 422).

At 904, the hosting application 104 determines whether one or more penalty conditions exist for the source element/candidate element pair being processed. Penalty conditions are described further below.

If the hosting application 104 determines that no penalty conditions exist at 904, processing proceeds to 906. In this case the distance calculated at 902 is returned as the final score for the source element/candidate element pair without any adjustment.

If the hosting application 104 determines that one or more penalty conditions do exist at 904, processing proceeds to 908. At 908 the hosting application 104 calculates a final score based on the distance score calculated at 902 and one or more penalties.

The hosting application 104 may be configured to determine the existence of (and apply a corresponding penalty for) various penalty conditions.

In one embodiment, the hosting application 104 is configured to determine the existence of what will be referred to as an intersection penalty condition at 904. Generally speaking, an intersection penalty condition occurs if the source element of a pair has an occluded region that intersects with the salient point or region of the candidate element of the pair.

The hosting application 104 determines whether an intersection penalty condition exists based on the source element's occlusion data (as generated or accessed at 410) and the candidate element's saliency data (as generated or accessed at 424).

Where salient regions are defined for candidate elements (e.g. by bounding box or other coordinates), the hosting application 104 will determine that an intersection penalty condition exists if a candidate element's salient region intersects with a source element's occlusion region—that is, if the two regions occupy the same two-dimensional position.

Where salient points are defined for candidate elements (e.g. by (x,y) coordinate pairs), the hosting application 104 will determine that an intersection penalty condition exists if a candidate element's salient point intersects with a source element's occlusion region—that is, if a candidate element's salient point is within a source element's occlusion region.

If the hosting application 104 determines that the intersection penalty condition exists, the hosting application 104 applies a penalty (which may be referred to as an intersection penalty) to the distance score calculated at 902 when determining the final score (at 908). The intersection penalty serves to artificially increase the distance between the source and candidate elements and make it less likely or impossible for the candidate element to be selected as the replacement element for the source element in downstream processing.

The hosting application 104 may be configured to apply different intersection penalties at 908. For example, if an intersection penalty condition exists, the hosting application 104 may be configured to add a predefined penalty value to the distance score calculated at 902 or multiply the distance score calculated at 902 by a predefined multiplier. In this case, an appropriate predefined penalty value or multiplier will depend on the distance measure used to calculate the distance score and the extent of the penalty desired. As one example, a multiplier of (positive) infinity may be used to prevent the candidate element from being selected as the replacement element for the source element if an intersection penalty condition exists.

By way of alternative example if an intersection penalty condition exists the hosting application 104 may be configured to calculate an intersection penalty value or multiplier based on the extent of the intersection—e.g. based on the area of the intersection between the candidate element's salient region(s) and the source element's occlusion region(s).

By way of further example, the hosting application 104 may also, or alternatively, be configured to determine the existence of what will be referred to as an aspect ratio penalty condition at 904. Generally speaking, an aspect ratio penalty condition will exist if the source element of a pair has an aspect ratio that does not match the aspect ratio of the candidate element of the pair. In this context, and as described above, hosting application 104 may enforce an exact match or may permit a tolerance.

If the hosting application 104 determines that the aspect ratio penalty condition exists, the hosting application 104 applies a penalty (which may be referred to as an aspect ratio penalty) to the distance score calculated at 902 when determining the final score (at 908). The aspect ratio penalty serves to artificially increase the distance between the source and candidate elements and make it less likely or impossible for the candidate element to be selected as the replacement element for the source element in downstream processing.

Various aspect ratio penalties may be applied. For example, if the aspect ratio penalty condition exists, the hosting application 104 may be configured to multiple the initial score by positive infinity. Alternative, the hosting application 104 may: add a predefined value to the initial score; add a calculated value to the initial score; multiply the initial score by an alternative predefined value; or multiply the initial sore by a calculated value. (In this example, calculated values may be calculated based on how close the aspect ratios of the source and candidate element are to one another.)

By way of further example, the hosting application 104 may also, or alternatively, be configured to determine the existence of what will be referred to as a colour penalty condition at 904. A colour penalty condition may exist, for example, if one of the source/candidate elements of the pair is colour and the other element is black and white (or greyscale).

In certain implementations, hosting application 104 may be configured to detect penalty conditions at 904 (and apply penalties at 908) instead of identifying source element cohorts (e.g. at step 414 of method 400 or step 816 of method 800) and candidate element cohorts (e.g. at step 418 of method 400 or step 820 of method 800).

To illustrate this, consider the example where source element and candidate elements cohorts are identified based on the aspect ratios of the source and candidate elements. Such selection serves the purpose of ensuring that a candidate element can only be selected as the replacement for a source element if has an aspect ratio that matches (e.g. is the same as or within a tolerance of) the source element's aspect ratio. Instead of identifying cohorts based on aspect ratio, however, calculating the scores for [candidate element, source element] pairs may involve determining whether an aspect ratio penalty exists and, if so, applying a penalty to the score. If the aspect ratio penalty exists for a source/candidate element pair, and the consequent penalty is to multiple the initial (distance) score for that pair by positive infinity, this will serve to prevent that source/candidate element pair as being selected (and, therefore, prevent the candidate element of the pair being selected as the replacement element for the source element of the pair).

In embodiments that make use of penalties in this way the identification of source and candidate element cohorts can be omitted. In such embodiments, any cohort criteria that are to be applied can instead be implemented by applying one or more penalties at 904 and 908.

Turning to FIG. 10, a computer-implemented method 1000 for processing a set of elements to automatically determine one or more collections will be described. Method 1000 will be described as being performed by the hosting application 104 but may be performed by one or more alternative applications.

Method 1000 takes as input (or has access to) a set of elements. Each element in the set of elements is associated with element metadata (e.g. element attributes as describe above) as well as element media (e.g. image, video, audio, or other media).

Method 1000 may, for example, be used at step 810 of method 800 to process a set of source elements to identify source element collections. Similarly, method 1000 may be used at step 812 of method 800 to process a candidate element pool to identify candidate element collections.

Alternatively, method 1000 may be used to identify element collection in any other appropriate set of source elements. For example, a user may want to process their photo library to automatically identify collections therein. In this case, a user may (for example) initiate method 1000 by activating a UI control such as control 314 described above. In response to activation of control 314, client application 112 may provide a further UI (or series of user interfaces) that allow a user to search or browse for, and select, a set of input elements (the set of input elements being the photos selected by the user).

At step 1004, the hosting application 104 identifies preliminary element clusters based on the element. Various metadata may be used. In the present embodiment, first (time) metadata and second (location) metadata are used at steps 1006 and 1008 respectively.

At step 1006, the hosting application 104 identifies time-based clusters. Such clusters may be, for example, identified based on a time associated with each element (e.g., time of a photo/image taken/created) and one or more time windows.

In some embodiments, the time window(s) may be defined by a user (e.g., the client application 112 may display appropriate UI to enable a user to define a particular window in terms of minutes/hours/days/weeks/months etc.). In other embodiments, the time window may be a predefined (e.g., the hosting application 112 is configured to use a fixed time window). In alternative embodiments, a K-means or other clustering technique may be used to automatically determine time-based clusters.

At step 1008, the hosting application 104 identifies location-based clusters for each time-based cluster. Such clusters may be, for example, identified based on location data associated with each element. The resulting clusters each contain a set of elements that have location data indicating close geographical proximity. It will be appreciated that various geographic clustering techniques may be used, for example, density-based spatial clustering of applications with noise (DBSCAN) algorithm or any alternative and suitable algorithm may be used.

Preliminary element clusters may be identified based on alternative attributes and/or using alternative techniques. By way of example, preliminary clusters may also (or alternatively) be identified based on attribute or metadata such as device data-e.g. a MAC address or other data that identifies a particular device (e.g. camera, smart phone, or other image capture device) used to capture an image and/or author data that identifies a person who created or captured the image.

Furthermore, while 1004 of the present example depicts the identification of preliminary clusters via a two-step process, preliminary clusters may be identified in a single operation. For example, instead of initially identifying time-based clusters then further identifying location-based clusters, the host application 104 may instead perform a single, multidimensional clustering process that determines clusters based on both time and location (e.g. a spatio-temporal clustering process).

Following step 1004, the hosting application 104 has produced a set of preliminary (metadata based) element clusters where each cluster is associated with one or more elements from the set of elements accessed at the step 1002.

At step 1010, the hosting application 104 identifies final element clusters based on the preliminary element clusters and the semantic content of the elements' media. This includes steps 1012, 1014, and 1016.

At step 1012, the hosting application 104 generates or accesses one or more element representations for each element in the input set of elements. This may be done, for example, according to step 408 of method 400 described earlier.

As described in relation to step 408 of method 400, element representations may capture information in respect of semantic content, style, or both semantic content and style of an element's media. In certain embodiments, a single representation is generated for each element (e.g., a CLIP or other embedding that captures content and style, or an embedding that captures only semantic content or only style). In other embodiments, multiple representations may be generated for each element, each representation capturing an aspect of the element (e.g. a semantic content representation and a separate style representation).

At step 1014, the hosting application 104 processes each element's representation(s) to generate reduced dimensionality element representation(s). This serves to reduce representations to a suitable size for downstream processing (in particular clustering) while preserving the essential characteristics of the representations/elements. For example, the application 104 may reduce dimensionality of each element representation using dimension reduction techniques. Any appropriate dimensionality reduction technique may be used, for example, Principal Component Analysis (PCA), t-Distributed Stochastic Neighbour Embedding (t-SNE), or an alternative technique. While reducing the dimensionality of element representations may reduce the processing required to identify final clusters at 1016, dimension reduction need not be performed.

At step 1016, the hosting application 104 identifies final clusters, which are the result of refining the preliminary element clusters created at the step 1004 using reduced dimensionality element representations generated at the step 1014 (or, if dimension reduction is not performed, the element representations generated or accessed at 1012). Specifically, the application 104 generates a combined feature set including the metadata-based features and the reduced dimensionality element representations. The application 104 then uses clustering techniques (e.g., K-means, Hierarchical Clustering, or an alternative clustering technique) to refine the preliminary element clusters based on the combined feature set. This approach may improve the identification of clusters such that the elements in each cluster are not only close in the selected metadata attributes (e.g. time and location) but are also similar in visual content.

Following step 1010, the hosting application 104 has identified a set of final (metadata-and content-based) clusters where each final cluster is associated with one or more elements from the set of input elements and every element from the set of input elements is associated with a single final cluster.

At step 1018, the hosting application 104 returns the element collections produced at the step 1010. The element collections may be returned in any appropriate manner. For example, each element collection may be returned as a set of element identifiers.

The hosting application 104 may, at step 1018, additionally or alternatively, update element metadata to indicate element collections. For example, each element's metadata may be updated to include a collection identifier that is populated with a unique identifier of the collection the element is associated with. Such metadata may be used to identify collections for any appropriate downstream purposes (e.g., as in the above methods, to group elements of a user's image library, or for an alternative purpose).

Turning to FIG. 11, a computer-implemented method 1100 for customising a design will be described.

Method 1100 will be described as being performed collectively by the client application 112 running on the client system 110 and the hosting application 104 running on the server system 102. In alternative embodiments, however, the processing described may be performed by one or more alternative applications running on a single system (e.g., client system 110 or an alternative system).

At step 1102, the client application 112 receives user input triggering design customisation. For example, the client application 112 receives user input activating the design customisation control 310 of the GUI 300. In other embodiments alternative methods for triggering design customisation may be used.

At step 1104, the client application 112 receives user input selecting a source design. For example, in response to the user input of 1102 the client application 112 may display a design selection UI that allows a user to browse/search for and select a source design via one or more user inputs.

At step 1106, the client application 112 displays the selected source design. For example, the selected source design may be displayed in the design preview area 302.

The application 112 may be configured to omit steps 1104 and 1106 if a design has already been opened/displayed. In this case, client application 112 may be configured to automatically select the displayed design as the source design when the user input triggering design customisation is received (at step 1102).

At step 1108, one or more source elements are identified in the source design. This may be done in various ways. In one embodiment, the client application 112 may receive one or more user inputs that select one or more source element(s) of the selected source design that are to be included in the set of source elements. In other embodiments, client application 112 (or an alternative application) may automatically determine the set of source elements as described above with reference to step 404 of method 400.

At step 1110, the hosting application 104 generates or accesses source element data for each source element determined at 1108. This processing may be the same as, or similar to, step 406 of method 400 described above.

At step 1112, the client application 112 receives user input identifying candidate pool. This operation may involve, e.g., displaying a candidate pool selection UI that allows a user to browse/search for an select a pool of candidate elements. In some embodiments, the client application 112 is configured to omit the step 1112, e.g., where a default/predefined candidate pool exists.

At step 1114, the hosting application 104 and/or the client application 112 determines a replacement element for each source element. In certain embodiments, this may involve operations the same as, or similar to, those described with reference to steps 412 to 416 of method 400 described above. In other embodiments, this may involve operations the same as, or similar to, those described with reference to steps 810 to 832 described above.

At step 1114, the hosting application 104 and/or the client application 112 generates a final design, for example per step 428 of method 400 described above or step 834 of method 800 described above. In this context, and particularly if the source design is a template design, generating a final design will typically involve generating a new design (based on the source design and replacement elements).

At step 1118, the client application 112 optionally displays the final design, e.g., in the preview area 302 of the UI 300. Including this step may be desirable to enable a user to perform downstream operations on the final design—e.g., to further amend, share, publish, or otherwise use the final design as required.

Turning to FIG. 12, an example computer-implemented method 1200 for replacing an asset across one or more designs will be described.

Method 1200 will be described as being performed collectively by the client application 112 running on the client system 110 and the hosting application 104 running on the server system 102. In alternative embodiments, however, the processing described may be performed by one or more alternative applications running on a single system (e.g., client system 110 or an alternative computer processing system).

At step 1202, the client application 112 receives user input triggering asset replacement. For example, the client application 112 receives user input activating the asset replacement control 312 of the GUI 300. In other embodiments alternative methods for triggering design customisation may be used.

At step 1204, the client application 112 receives user input selecting an asset. For example, the client application 112 may display an asset selection UI that allows a user to browse/search for and select an asset (e.g., from a user's asset library or other libraries).

At step 1206, the hosting application 104 generates or accesses one or more asset representations in respect of the asset. This processing may be the same as, or similar to, step 408 of method 400 described above (with the asset being treated as a source element).

At step 1208, the hosting application 104 identifies design(s) that include at least one element that corresponds to the asset selected at 1204. make use of (e.g., include instances of) the selected asset. This may be done in various manners. For example, the hosting application 104 may process each design that is available to a user to examine whether the selected asset is used at least once in the design, in which case the design is selected at the step 1208. By way of alternative example, asset usage data may be available that provides associations between a particular asset any designs that asset has been used in. Australian patent application 2023201507 filed on 10 Mar. 2023 and titled “Systems and methods for performing bulk design edits” provides one example of such asset usage data. Where asset usage data such as this is available hosting application 104 may query the asset usage data to identify designs that make user of the asset.

At step 1210, the client application 112 displays the identified design(s). In some embodiments, a UI may be displayed that provides a list of designs that include the selected asset. In some embodiments, such a UI may contain thumbnail of other methods for previewing each design.

At step 1212, source designs are determined—that is, designs that include one or more instances of the selected asset and in which the instance(s) of the selected asset are to be replaced. In certain embodiments, the client application 112 determines the source designs based on further user input selecting source designs. For example, a user may select the designs that are to be updated. In some embodiments, this step may include individual design selection/deselection and/or operations of a select all and/or deselect all controls. Once user inputs selecting/deselecting designs (if any) are received, the client application 112 receives input confirming asset replacement to be performed for the selected design(s).

In other embodiments, the hosting application 104 (or the client application 112) may automatically select all designs identified at 1208 as source designs without displaying any UI or otherwise providing the user with opportunity to select/deselect certain designs and/or confirm the selection. In this case step 1210 can be omitted.

At step 1214, the hosting application 104 and/or the client application 112 determine a replacement element for each instance of the selected asset that occurs in each in design identified at 1208 (and. If done, selected at 1212). Various approaches to determining a replacement element for each instance of the selected asset may be adopted based on the techniques described herein.

In one embodiment, the hosting application 104 is configured to identify a single (same) replacement element for the selected asset and then use that single replacement element to replace all instances of the selected asset in all of the designs that have been selected (either automatically or at 1212). In this case, the single replacement element may be determined by: determining a candidate element cohort for the selected asset (e.g. as per step 418 of method 400 and based, for example, on the aspect ratio of the selected asset); generating or accessing candidate element data (e.g. as per step 420 of method 400); and then determining a replacement element (e.g. as per step 426 of method 400). In this example there is, effectively, a single replacement element being identified for a single source element (even though that single replacement element may be used to replace multiple instances of the source element across multiple designs). Accordingly, identifying a replacement element according to method 500 may be appropriate.

In alternative embodiments, there may be a need (or desire) to replace each instance of the selected asset with a different replacement element. In this case, the hosting application 104 may be configured to treat all instances of the selected asset (in all selected designs) as a single cohort of a single set of source elements: i.e. a single cohort that includes x repeats of the same source element (x being the number of instances of the selected asset in the source designs selected). In this case, replacement elements for the instances of the selected asset may be determined by: determining a candidate element cohort for the selected asset (e.g. as per step 418 of method 400 and based, for example, on the aspect ratio of the selected asset); generating or accessing candidate element data (e.g. as per step 420 of method 400); and then determining a replacement element for each instance of the selected asset (e.g. as per step 426 of method 400). In order to avoid duplicate replacement elements being identified, identifying replacement elements according to method 600 or 700 will be appropriate.

At step 1216, the hosting application 104 and/or the client application 112 generates a final design corresponding to each source design, for example per step 428 of method 400 described above or step 834 of method 800 described above. In this context, generating final designs will typically involve updating the existing source designs (based on the replacement elements).

At step 1218, the client application 112 optionally displays the final design(s) or preview(s) thereof. Including this step may be desirable, e.g., to enable a user to check and/or further amend the final design(s) as required.

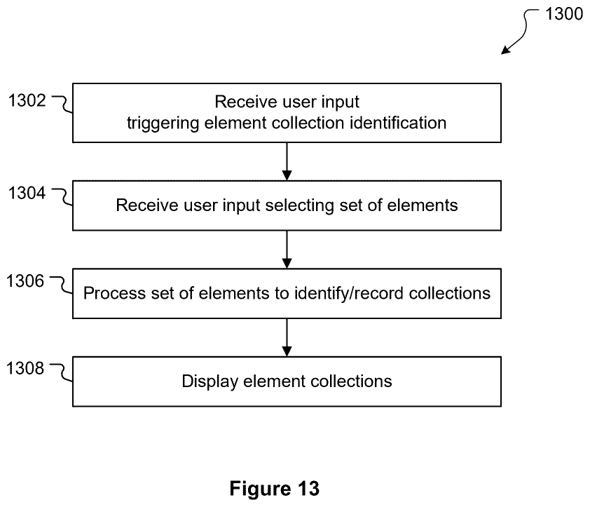

Turning to FIG. 13, an example computer-implemented method 1300 for determining element collections within a set of input elements will be described.

Method 1300 will be described as being performed collectively by the client application 112 running on the client system 110 and the hosting application 104 running on the server system 102. In alternative embodiments, however, the processing described may be performed by one or more alternative applications running on a single system (e.g., the client system 110 or another computer processing system).

At step 1302, the client application 112 receives user input triggering element collection identification. For example, the client application 112 receives user input activating the identify element collections control 314 of the GUI 300. In other embodiments alternative methods for triggering design customisation may be used.

At step 1304, the client application 112 receives user input selecting an input set of elements. In some embodiments, the selection may involve displaying an element set selection UI that allows a user to browse/search for an select a set of elements (e.g., a folder, directory, or other location that contains a user/s photos or other media).

At step 1306, the hosting application 104 processes the set of input elements according to method 1000 described above. In addition, the hosting application 104 may record the collections that are identified.

At step 1308, the client application 112 optionally displays the element collections, e.g., by displaying an element collections UI. Including this step may be desirable, e.g., to enable a user to further amend the element collections (e.g., disregarding some of collections, adding elements to certain collections, or moving elements between the collections).

The following first set of numbered clauses describe additional, specific embodiments of the disclosure:

Clause 1. A computer implemented method for generating a final design based on a source design, the method including:
processing the source design using one or more processing units to identify a set of source elements, wherein the set of source elements includes one or more elements of the source design and includes a first source element;
processing the set of source elements to generate source element data, wherein generating the source element data includes generating first source element data in respect of the first source element, and wherein the first source element data includes a first source element representation that is a representation of the semantic content of the first source element;
accessing candidate element data in respect of a set of candidate elements, wherein the set of candidate elements includes a plurality of candidate elements and the candidate element data includes a candidate element representation for each candidate element in the set of candidate elements, and wherein each candidate element representation is a representation of the semantic content of the corresponding candidate element;
identifying a set of replacement elements for the set of source elements, wherein the set of replacement elements is identified based on the source element data and the candidate element data and wherein identifying the set of replacement elements includes identifying a first candidate element from the set of candidate elements as a replacement for the first source element based on the first source element representation and a first candidate element representation in respect of the first candidate element; and
generating a final design based on the source design and the set of replacement elements, wherein in the final design the first candidate element is used in place of the first source element.

Clause 2. The computer implemented method of clause 1, wherein the first source element representation is an embedding and each candidate element representation is an embedding.

Clause 3. The computer implemented method of clause 1 or clause 2, wherein the first source element representation is a multi-modal embedding and each candidate element representation is a multi-modal embedding.

Clause 4. The computer implemented method of any one of clauses 1 to 3, wherein generating first source element data includes processing the first source element using a first trained machine learning model to generate the first source element representation.

Clause 5. The computer implemented method of clause 4, further including processing each candidate element in the set of candidate elements using the first trained machine learning model to generate the candidate element representations.

Clause 6. The computer implemented method of any one of clauses 1 to 6, further including:
processing the set of source elements to identify a first source element cohort, wherein the first source element cohort includes one or more source elements from the set of source elements that satisfy a first cohort criterion, and wherein the first source element cohort includes the first source element; and
processing the set of candidate elements to identify a first candidate element cohort, wherein the first candidate element cohort includes one or more candidate elements from the set of candidate elements that satisfy the first cohort criterion, and wherein the first candidate element cohort includes the first candidate element.

Clause 7. The computer implemented method of clause 6, wherein the first cohort criterion is based on aspect ratio.

Clause 8. The computer implemented method of any one of clauses 1 to 7, further including:
processing the set of source elements to identify a first source element collection, wherein the first source element collection includes one or more source elements from the set of source elements that have a contextual or semantic relationship with one another; and
processing the set of candidate elements to identify a first candidate element collection, wherein the first candidate element collection includes one or more candidate elements from the set of candidate elements that have a contextual or semantic relationship with one another, and wherein the first candidate cohort includes the first candidate element.

Clause 9. The computer implemented method of any one of clauses 1 to 8, wherein identifying the first candidate element as the replacement for the first source element includes:
calculating a first score in respect of the first source element and the first candidate element, wherein the first score is based on a distance between the first source element representation and the first candidate element representation;
calculating a second score in respect of the first source element and a second candidate element, wherein the second score is based on a distance between the first source element representation and a second candidate element representation in respect of the second candidate element; and
determining that the first score is better than the second score.

Clause 10. The computer implemented method of any one of clauses 1 to 9, wherein:
the set of source elements includes a second source element that is an element of the source design;
processing the set of source elements to generate source element data includes generating second source element data in respect of the second source element, and wherein the second source element data includes a second source element representation that is a representation of the semantic content of the second source element; and
identifying the set of replacement elements for the set of source elements includes:
   removing the first candidate element as a possible replacement element for the second source element; and
   identifying a third candidate element from the set of candidate elements as a replacement for the second source element based on the second source element representation and a third candidate element representation in respect of the third candidate element.

Clause 11. The computer implemented method of any one of clauses 1 to 10, wherein:
identifying the set of replacement elements for the set of source elements includes generating a set of pairwise scores that includes a score for each source element/candidate element pair; and
the score for a particular source element/candidate element pair is based on a distance between a source element representation generated for the particular pair's source element and a candidate element representation generated for the particular pair's candidate element.

Clause 12. The computer implemented method of clause 11, wherein generating the set of pairwise scores includes generating a first pairwise score in respect of a first pair that includes the first source element and a fourth candidate element from the set of candidate elements, and wherein generating the first pairwise score includes:
calculating a distance score based on a distance between the first source element representation and a fourth candidate element representation associated with the fourth candidate element;
determining that an occluded region of the first source element intersects with a salient region of the fourth candidate element; and
in response to determining that the occluded region of the first source element intersection with the salient region of the fourth candidate element, generating the first pairwise score based on the distance score and a penalty.

Clause 13. The computer implemented method of clause 12, wherein the penalty is one of: a value that is added to the distance score; and a multiplier that the distance score is multiplied by.

Clause 14. The computer implemented method of clause 12, wherein the penalty is calculated based on an extent to which the occluded region of the first source element intersects with the salient region of the fourth candidate element.

Clause 15. The computer implemented method of any one of clauses 11 to 14, wherein identifying the set of replacement elements for the set of source elements includes processing the set of pairwise scores using an assignment problem approach to assign each source element to a candidate element.

Clause 16. The computer implemented method of any one of clauses 1 to 15, wherein generating the final design includes updating the source design.

Clause 17. The computer implemented method of any one of clauses 1 to 15, wherein generating the final design includes creating a copy of the source design.

The following second set of numbered clauses describe additional, specific embodiments of the disclosure:

Clause 1. A computer implemented method for calculating a final score for use in determining whether a candidate element should be selected to replace a source element of a source design, the method including:
processing the source element using one or more processing units to generate source element data, wherein the source element data includes a source element representation that is a representation of the semantic content of the source element and occlusion data that that indicates an occluded region of the source element, the occluded region of the source element being a region of the source element that is occluded by another element in the source design;
accessing candidate element data, wherein the candidate element data includes a candidate element representation that is a representation of the semantic content of the candidate element and saliency data that that indicates a salient point or region of the candidate element;
calculating a distance score based on a distance between the first source element representation and a third candidate element representation associated with the third candidate element;
determining, based on the occlusion data and the saliency data, that the occluded region of the source element intersects with the salient point or region of the candidate element; and
generating the final score based on the distance score and a penalty.

Clause 2. The computer implemented method of clause 1, wherein the penalty is one of: a predefined value that is added to the distance score; and a predefined multiplier that the distance score is multiplied by.

Clause 3. The computer implemented method of clause 1, wherein the penalty is calculated based on an extent to which the occluded region of the source element intersects with the salient point or region of the candidate element.

Clause 4. The computer implemented method of any one of clauses 1 to 3, wherein the source element representation and candidate element representation are embeddings.

Clause 5. The computer implemented method of any one of clauses 1 to 4, wherein the source element representation and candidate element representation are multi-modal embeddings.

Clause 6. The computer implemented method of any one of clauses 1 to 5, wherein processing the source element to generate the source element data includes processing the source element using a first trained machine learning model to generate the source element representation.

Clause 7. The computer implemented method of any one of clauses 1 to 6, further including processing the candidate element to generate the saliency data, and wherein processing the candidate element to generate the saliency data includes processing the candidate element using a second machine learning model that has been trained to detect salient objects in images.

The following third set of numbered clauses describe additional, specific embodiments of the disclosure:

Clause 1. A computer implemented method including:
receiving first user input selecting an asset;
processing the asset using one or more processing units to generate an asset representation that is a representation of the semantic content of the asset;
automatically identifying a first source design that includes a first source element that corresponds to the asset;
accessing candidate element data in respect of a set of candidate elements, wherein the set of candidate elements includes a plurality of candidate elements and the candidate element data includes a candidate element representation for each candidate element in the set of candidate elements, and wherein each candidate element representation is a representation of the semantic content of the corresponding candidate element;
identifying a first candidate element from the set of candidate elements as a replacement for the first source element based on the asset representation and a first candidate element representation in respect of the first candidate element; and
updating the first source design by replacing the first source element with the first candidate element.

Clause 2. The computer implemented method of clause 1, further including:
automatically identifying a second source design that includes a second source element that corresponds to the asset;
identifying the first candidate element from the set of candidate elements as a replacement for the second source element based on the asset representation and the first candidate element representation; and
updating the second source design by replacing the second source element with the first candidate element.

Clause 3. The computer implemented method of clause 1, further including:
automatically identifying a second source design that includes a second source element that corresponds to the asset;
identifying a second candidate element from the set of candidate elements as a replacement for the second source element based on the asset representation and a second candidate element representation in respect of the second candidate element; and
updating the second source design by replacing the first source element with the second candidate element.

Clause 4. The computer implemented method of any one of clauses 1 to 3, wherein the asset representation is an embedding and each candidate element representation is an embedding.

Clause 5. The computer implemented method of any one of clauses 1 to 4, wherein the asset representation is a multi-modal embedding and each candidate element representation is a multi-modal embedding.

Clause 6. The computer implemented method of any one of clauses 1 to 5, wherein generating the asset representation includes processing the asset using a trained machine learning model.

Clause 7. The computer implemented method of any one of clauses 1 to 6, further including processing each candidate element in the set of candidate elements using a trained machine learning model to generate the corresponding candidate element representation.

Clause 8. The computer implemented method of any one of clauses 1 to 7, further including determining the set of candidate elements based on an aspect ratio of the asset.

Clause 9. The computer implemented method of any one of clauses 1 to 8, wherein identifying the first candidate element as the replacement for the first source element includes determining that the asset representation is closer in distance to the first candidate element representation than to any other candidate element representation.

The following fourth set of numbered clauses describe additional, specific embodiments of the disclosure:

Clause 1. A computer implemented method including:
accessing a set of elements, wherein the set of elements includes a plurality of elements and each element is associated with element metadata and element media;
processing the set elements using one or more processing units to identify one or more preliminary element clusters, wherein the preliminary element clusters are identified based on the element metadata;
processing each element in the set of elements to generate a corresponding element representation, wherein each element representation is a representation of the semantic content of the element's media;
processing each preliminary element cluster to identify one or more final clusters, wherein each final cluster is identified based on the element representations of the elements in the preliminary element cluster.

Clause 2. The computer implemented method of clause 1, wherein each element representation is an embedding.

Clause 3. The computer implemented method of clause 1 or clause 2, wherein each element representation is a multi-modal embedding.

Clause 4. The computer implemented method of any one of clauses 1 to 3, wherein processing each element to generate the corresponding element representation includes processing each element using a trained machine learning model.

Clause 5. The computer implemented method of any one of clauses 1 to 4, wherein the preliminary element clusters are identified based on time metadata.

Clause 6. The computer implemented method of any one of clauses 1 to 5, wherein the preliminary element clusters are identified based on location metadata.

Additional specific embodiments of the present disclosure include a computer processing system including:
one or more processing units; and
one or more non-transitory computer-readable storage media storing instructions, which when executed by the one or more processing units, cause the one or more processing units to perform a method according to any one of: clauses 1 to 17 of the first set of numbered clauses; clauses 1 to 7 of the second set of numbered clauses; clauses 1 to 9 of the third set of numbered clauses; or clauses 1 to 6 of the fourth set of numbered clauses.

Additional specific embodiments of the present disclosure include one or more non-transitory storage media storing instructions executable by one or more processing units to cause the one or more processing units to perform a method according to any one of: clauses 1 to 17 of the first set of numbered clauses; clauses 1 to 7 of the second set of numbered clauses; clauses 1 to 9 of the third set of numbered clauses; or clauses 1 to 6 of the fourth set of numbered clauses.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, operations, steps, or elements.

Unless required by context, the terms “first”, “second”, etc. are used to differentiate between various elements and features and not in an ordinal sense. For example, a first feature could be termed a second feature, and, similarly, a second feature could be termed a first feature, without departing from the scope of the described examples.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer implemented method for generating a final design based on a source design, the method including:
processing the source design using one or more processing units to identify a set of source elements, wherein the set of source elements includes one or more elements of the source design and includes a first source element;
processing the set of source elements to generate source element data, wherein generating the source element data includes generating first source element data in respect of the first source element, and wherein the first source element data includes a first source element representation that is a representation of the semantic content of the first source element;
accessing candidate element data in respect of a set of candidate elements, wherein the set of candidate elements includes a plurality of candidate elements and the candidate element data includes a candidate element representation for each candidate element in the set of candidate elements, and wherein each candidate element representation is a representation of the semantic content of the corresponding candidate element;
identifying a set of replacement elements for the set of source elements, wherein the set of replacement elements is identified based on the source element data and the candidate element data and wherein identifying the set of replacement elements includes identifying a first candidate element from the set of candidate elements as a replacement for the first source element based on the first source element representation and a first candidate element representation in respect of the first candidate element; and
generating a final design based on the source design and the set of replacement elements, wherein in the final design the first candidate element is used in place of the first source element.

2. The computer implemented method of claim 1, wherein the first source element representation is a multi-modal embedding and each candidate element representation is a multi-modal embedding.

3. The computer implemented method of claim 1, wherein:
generating the first source element data includes processing the first source element using a first trained machine learning model to generate the first source element representation; and the method further includes processing each candidate element in the set of candidate elements using the first trained machine learning model to generate the candidate element representations.

4. The computer implemented method of claim 1, further including:
processing the set of source elements to identify a first source element cohort, wherein the first source element cohort includes one or more source elements from the set of source elements that satisfy a first cohort criterion, and wherein the first source element cohort includes the first source element; and
processing the set of candidate elements to identify a first candidate element cohort, wherein the first candidate element cohort includes one or more candidate elements from the set of candidate elements that satisfy the first cohort criterion, and wherein the first candidate element cohort includes the first candidate element.

5. The computer implemented method of claim 4, wherein the first cohort criterion is based on aspect ratio.

6. The computer implemented method of claim 1, further including:
processing the set of source elements to identify a first source element collection, wherein the first source element collection includes one or more source elements from the set of source elements that have a contextual or semantic relationship with one another, and wherein the first source element collection includes the first source element; and
processing the set of candidate elements to identify a first candidate element collection, wherein the first candidate element collection includes one or more candidate elements from the set of candidate elements that have a contextual or semantic relationship with one another, and wherein the first candidate collection includes the first candidate element.

7. The computer implemented method of claim 1, wherein identifying the first candidate element as the replacement for the first source element includes:
calculating a first score in respect of the first source element and the first candidate element, wherein the first score is based on a distance between the first source element representation and the first candidate element representation;
calculating a second score in respect of the first source element and a second candidate element, wherein the second score is based on a distance between the first source element representation and a second candidate element representation in respect of the second candidate element; and
identifying the first candidate element as the replacement for the first source element based on the first score and the second score.

8. The computer implemented method of claim 1, wherein:
the set of source elements includes a second source element that is an element of the source design;
processing the set of source elements to generate source element data includes generating second source element data in respect of the second source element, and wherein the second source element data includes a second source element representation that is a representation of the semantic content of the second source element; and
identifying the set of replacement elements for the set of source elements includes:
removing the first candidate element as a possible replacement element for the second source element; and
identifying a third candidate element from the set of candidate elements as a replacement for the second source element based on the second source element representation and a third candidate element representation in respect of the third candidate element.

9. The computer implemented method of claim 1, wherein:
identifying the set of replacement elements for the set of source elements includes generating a set of pairwise scores that includes a score for each source element/candidate element pair; and
the score for a particular source element/candidate element pair is based on a distance between a source element representation generated for the particular pair's source element and a candidate element representation generated for the particular pair's candidate element.

10. The computer implemented method of claim 9, wherein generating the set of pairwise scores includes generating a first pairwise score in respect of a first pair that includes the first source element and a fourth candidate element from the set of candidate elements, and wherein generating the first pairwise score includes:
calculating a distance score based on a distance between the first source element representation and a fourth candidate element representation associated with the fourth candidate element;
determining that an occluded region of the first source element intersects with a salient region of the fourth candidate element; and
in response to determining that the occluded region of the first source element intersection with the salient region of the fourth candidate element, generating the first pairwise score based on the distance score and a penalty.

11. A computer processing system including:
one or more processing units; and
one or more non-transitory computer-readable storage media storing instructions, which when executed by the one or more processing units, cause the one or more processing units to perform a method for generating a final design based on a source design, wherein the method includes:
processing the source design to identify a set of source elements, wherein the set of source elements includes one or more elements of the source design and includes a first source element;
processing the set of source elements to generate source element data, wherein generating the source element data includes generating first source element data in respect of the first source element, and wherein the first source element data includes a first source element representation that is a representation of the semantic content of the first source element;
accessing candidate element data in respect of a set of candidate elements, wherein the set of candidate elements includes a plurality of candidate elements and the candidate element data includes a candidate element representation for each candidate element in the set of candidate elements, and wherein each candidate element representation is a representation of the semantic content of the corresponding candidate element;
identifying a set of replacement elements for the set of source elements, wherein the set of replacement elements is identified based on the source element data and the candidate element data and wherein identifying the set of replacement elements includes identifying a first candidate element from the set of candidate elements as a replacement for the first source element based on the first source element representation and a first candidate element representation in respect of the first candidate element; and
generating a final design based on the source design and the set of replacement elements, wherein in the final design the first candidate element is used in place of the first source element.

12. The computer processing system of claim 11, wherein the first source element representation is a multi-modal embedding and each candidate element representation is a multi-modal embedding.

13. The computer processing system of claim 11, wherein:
generating the first source element data includes processing the first source element using a first trained machine learning model to generate the first source element representation; and the method further includes processing each candidate element in the set of candidate elements using the first trained machine learning model to generate the candidate element representations.

14. The computer processing system of claim 11, wherein the method further includes:
processing the set of source elements to identify a first source element cohort, wherein the first source element cohort includes one or more source elements from the set of source elements that satisfy a first cohort criterion, and wherein the first source element cohort includes the first source element; and
processing the set of candidate elements to identify a first candidate element cohort, wherein the first candidate element cohort includes one or more candidate elements from the set of candidate elements that satisfy the first cohort criterion, and wherein the first candidate element cohort includes the first candidate element.

15. The computer processing system of claim 14, wherein the first cohort criterion is based on aspect ratio.

16. The computer processing system of claim 11, wherein the method further includes:
processing the set of source elements to identify a first source element collection, wherein the first source element collection includes one or more source elements from the set of source elements that have a contextual or semantic relationship with one another, and wherein the first source element collection includes the first source element; and
processing the set of candidate elements to identify a first candidate element collection, wherein the first candidate element collection includes one or more candidate elements from the set of candidate elements that have a contextual or semantic relationship with one another, and wherein the first candidate collection includes the first candidate element.

17. The computer processing system of claim 11, wherein:
the set of source elements includes a second source element that is an element of the source design;
processing the set of source elements to generate source element data includes generating second source element data in respect of the second source element, and wherein the second source element data includes a second source element representation that is a representation of the semantic content of the second source element; and
identifying the set of replacement elements for the set of source elements includes:
removing the first candidate element as a possible replacement element for the second source element; and
identifying a third candidate element from the set of candidate elements as a replacement for the second source element based on the second source element representation and a third candidate element representation in respect of the third candidate element.

18. The computer processing system of claim 11, wherein:
identifying the set of replacement elements for the set of source elements includes generating a set of pairwise scores that includes a score for each source element/candidate element pair; and
the score for a particular source element/candidate element pair is based on a distance between a source element representation generated for the particular pair's source element and a candidate element representation generated for the particular pair's candidate element.

19. The computer processing system of claim 18, wherein generating the set of pairwise scores includes generating a first pairwise score in respect of a first pair that includes the first source element and a fourth candidate element from the set of candidate elements, and wherein generating the first pairwise score includes:
calculating a distance score based on a distance between the first source element representation and a fourth candidate element representation associated with the fourth candidate element;
determining that an occluded region of the first source element intersects with a salient region of the fourth candidate element; and
in response to determining that the occluded region of the first source element intersection with the salient region of the fourth candidate element, generating the first pairwise score based on the distance score and a penalty.

20. One or more non-transitory storage media storing instructions executable by one or more processing units to cause the one or more processing units to perform a method for generating a final design based on a source design, wherein the method includes:
processing the source design to identify a set of source elements, wherein the set of source elements includes one or more elements of the source design and includes a first source element;
processing the set of source elements to generate source element data, wherein generating the source element data includes generating first source element data in respect of the first source element, and wherein the first source element data includes a first source element representation that is a representation of the semantic content of the first source element;
accessing candidate element data in respect of a set of candidate elements, wherein the set of candidate elements includes a plurality of candidate elements and the candidate element data includes a candidate element representation for each candidate element in the set of candidate elements, and wherein each candidate element representation is a representation of the semantic content of the corresponding candidate element;
identifying a set of replacement elements for the set of source elements, wherein the set of replacement elements is identified based on the source element data and the candidate element data and wherein identifying the set of replacement elements includes identifying a first candidate element from the set of candidate elements as a replacement for the first source element based on the first source element representation and a first candidate element representation in respect of the first candidate element; and
generating a final design based on the source design and the set of replacement elements, wherein in the final design the first candidate element is used in place of the first source element.
